(19) United States
(12) Patent Application Publication
(10) Pub. No.: US 2013/0232424 A1
(43) Pub. Date: Sep. 5, 2013

(54) USER OPERATION DETECTION SYSTEM AND USER OPERATION DETECTION METHOD

(71) Applicants: Hiroshi Nakagoe, Tokyo (JP); Katsuo Nakashima, Yamato (JP)

(72) Inventors: Hiroshi Nakagoe, Tokyo (JP); Katsuo Nakashima, Yamato (JP)

(73) Assignee: HITACHI, LTD., Tokyo (JP)

(21) Appl. No.: 13/582,004

(22) PCT Filed: Mar. 2, 2012
(86) PCT No.: PCT/JP12/55458

§ 371 Date: Aug. 30, 2012

(51) Int. Cl. G06F 3/0484

(52) U.S. Cl. CPC G06F 3/0484
USPC 715/738

(57) ABSTRACT

The present invention provides a system for detecting and recording a user operation with respect to a web application. This system extracts from an application screen both a character string input element for the user to input a character string and an execution instruction element for instructing the web application to execute a prescribed operation. This system infers the role of the character string input element and execution instruction element in the web application. This system associates the character string input element with the execution instruction element, and extracts an inputted character string, which is inputted to the character string input element. This system creates user operation record data, which is recorded with a user operation, based on template data and the inputted character string.

### TECHNICAL FIELD

The present invention relates to a user operation detection system and a user operation detection method.

### BACKGROUND ART

Attention has been focusing in recent years on products for monitoring user operations on client terminals, such as company-managed personal computers (PCs) and smartphones.

A product, which monitors a user's operations, not only provides the monitor with simple access logs for a device and files, but also provides a log, which includes context, such as “how the user processed a certain file at a certain date and time”. According to Patent Literature 1, the log's acquisition range extends to devices like printers in addition to various types of desktop applications, such as browsers, mailers, and filers.

The technology disclosed in Patent Literature 1 not only monitors a file I/O (Input/Output) and a communication I/O on a client terminal, but also monitors a screen of an application program running on the client terminal. The technology disclosed in Patent Literature 1 assigns an identifier beforehand to a file, which will be obtained in accordance with a user operation. When an attempt is being made to output a file in accordance with a user operation, the technology disclosed in Patent Literature 1 determines whether or not output is permissible by verifying the identifier assigned to this file.

Meanwhile, in line with the progress of Web technologies, such as cloud services and RIA (Rich Internet Application), applications are not only being provided as desktop applications, but have also begun to be provided as Web applications, which are realized by communicating data between the client side and the server side.

The user uses Web (WWW) application display software, such as a Web browser installed on the client terminal to access a server, which provides a Web application. The user can use the Web application in accordance with communication of data required for application development between the browser and the server.

The browser renders a screen based on data obtained from the server. The user performs a prescribed operation with respect to this screen. Triggered by an event caused by this user operation, the browser sends a request to the server. Upon obtaining a response from the server, the browser re-renders the screen using this response data.

Specifically, the browser and the server use HTTP (Hyper Text Transfer Protocol) as a communication protocol to communicate a HTML (Hyper Text Markup Language), a CSS (Cascading Style Sheet), JavaScript (registered trademark) and other such resource files. The browser uses these resource files to render an application screen.

The HTML is a file for describing the configurations of a screen and a document. The CSS is a file for describing the style of the entire screen and each type of component described in the HTML. The JavaScript is a file for defining the operation of each type of component described in the HTML.

HTML is a standard, and is a language for writing an application structure using a text format. FIG. 22 shows an example of HTML. HTML configures a document using a tag and other such delimiters.

A term, which is differentiated by delimiters, is an element, an attribute, a text, and so forth. In FIG. 22, the terms html and title, which are enclosed by tags, are elements, href is an attribute name, “http://˜” is an attribute value, and “link 1” is a text. Furthermore, FIG. 22 simply shows the structure, which constitutes the basics of HTML, and, for example, style descriptions and JavaScript codes are omitted.

The browser must convert the HTML, which is written using a text format, to a binary format, which is a format capable of being analyzed by a computer. The HTML is designed such that an element, a text, and so forth comprising a relevant document are embedded structures. That is, in HTML, a certain element and text always have a parent element. By making use of this characteristic feature, an HTML document can be treated as tree-structured data having n-ary branches.

Specifically, an element constituting the vertex is connected as a root node, an element, an attribute, or a text following this root node is connected as a child node of the root node, or as a child node of this child node. The tree-structured data converted from this HTML is generally called a DOM tree. FIG. 23 is an example in which the HTML of FIG. 22 has been made into tree-structured data. In FIG. 23, the attribute and the text are regarded as one node, but the present invention is not limited to this.

That is, in the HTML of FIG. 22, the node comprising element a can also be configured as a node having the attribute name href and the attribute value “http://˜” therein. This is because an API (Application Programming Interface), which is provided to an application for using an HTML document processor to analyze the HTML, has been defined, but a method for writing the relevant HTML document processor inside the HTML has not been defined.

In the technology disclosed in Patent Literature 2, the properties of the HTML elements comprising a Web application can be identified and converted to another format. In Patent Literature 2, a schema of a target XML (eXtensible Markup Language) document is converted to an ontology model. The technology of Patent Literature 2 uses the converted ontology model to extract a corresponding relationship between an element of the target XML document and an element of another XML document, and automatically creates a XSLT (XSL Transformations) in which a conversion rule showing the corresponding relationship between the elements is described. The schema is a file, which stores standard information conforming to the target XML document, such as the kind of element(s) and attribute(s) that an element inside an XML document can have.

In the technology disclosed in Patent Literature 3, a user-inputted character string can be acquired from a Web application screen. In Patent Literature 3, a name, address, and zip code are identified by extracting a character string from an address label or other such image data, and analyzing the characteristics of the extracted character string. In Patent Literature 3, when a numeral is included in the target character string, this numeral is inferred to be a zip code, when a partial character string, which is included in an address database, is included in the target character string, this partial character string is inferred to be an address, and when a partial character string, which is included in a name database, is included in the target character string, this partial character string is inferred to be a name.

### CITATION LIST

### Patent Literature

[PTL 1]
Japanese Patent Application Laid-open No. 2011-186861
[PTL 2]
Japanese Patent Application Laid-open No. 2003-233528
[PTL 3]
Japanese Patent Application Laid-open No. H5-217015

### SUMMARY OF INVENTION

### Technical Problem

In the technology disclosed in Patent Literature 1, only file input/output information of a browser on which a Web application is running and Web application URI (Uniform Resource Identifier) information generated by this file input/output are monitored. Therefore, in the technology of Patent Literature 1, it is not possible to record a user's operations on the Web application to a degree of preciseness, which states “what a user processed and how he processed it on the Web application on a certain date and time”.

Specifically, a Webmail application will be explained as an example. In the technology disclosed in Patent Literature 1, when the user executes an operation for attaching a file to an email message in the Webmail application, a log stating simply that “a file has been uploaded in the Webmail application domain” is created. However, what really needs to be acquired is a precise log stating that “user A sent an ˜email message to address B at such-and-such a time and also sent a file”.

In the technology disclosed in Patent Literature 1, a log of the desired degree of preciseness cannot be acquired because the operations of the user on the Web application are not discernable. More accurately, in the technology disclosed in Patent Literature 1, it is completely impossible to discern what the user inputted and what his intentions were in doing so with respect to the various elements comprising a Web application.

In a case where the technology disclosed in Patent Literature 2 can be used to acquire a log of a user's operations on a Web application, it may be possible to derive an element relationship from an identified attributed specified in this identified element, and to convert this element relationship to an operation log format.

However, the HTML currently configuring most Web applications comprises elements, which do not include attributes for deriving a target relationship. That is, in a case where metadata and an attribute are defined and a Web application is configured using HTML, which conforms to these definitions, it might be possible to acquire a user operation log for a Web application using the technology disclosed in Patent Literature 2. However, the technology disclosed in Patent Literature 2 is not valid for most Web applications currently in use.

It is not possible to use the technology disclosed in Patent Literature 3 to acquire a log of user operations on a Web application. Firstly, in the technology disclosed in Patent Literature 3, it is not possible to determine whether a user application operation has been completed, and as such, it is completely impossible to determine the timing at which a character string may be acquired. Therefore, in the technology disclosed in Patent Literature 3, it is not possible to acquire a character string suitable for analyzing a user operation log.

Secondly, in the technology disclosed on Patent Literature 3, an address database and a name database must be prepared, and, in addition, these databases must be updated at all times. Therefore, the technology disclosed in Patent Literature 3 requires a huge storage capacity, takes time to update the databases, and increases costs.

Thirdly, the technology disclosed in Patent Literature 3 is processing intensive since it requires that a set of input boxes into which the user might perform inputting be extracted from inside the Web application screen, and that analysis be performed on a character string within this set of input boxes. Therefore, in a case where user operation logs are monitored for a large number of users, the processing speed slows down and usability also worsens.

The present invention has been made with the foregoing problems in view, and provides a user operation detection system and a user operation detection method, which make it possible to acquire a user operation performed using a client terminal with respect to a web application in accordance with a relatively simple configuration.

### Solution to the Problem

A user operation detection system related to the present invention is for detecting a user operation performed in use of a client terminal for a web application running on a server, and comprises a first element extraction part for extracting from an application screen provided by a web application both a character string input element for the user to input a character string and an execution instruction element for instructing the web application to execute a prescribed operation, a role inference part for inferring the role of the extracted character string input element and execution instruction element in the web application, an element association part for associating the character string input element with the execution instruction element, a character string extraction part for extracting a character string, which has been inputted to a character string input element associated with an execution instruction element, a template storage part for storing template data, which is prepared in accordance with the type of a web application and is for recording a user operation with respect to the web application, and a user operation record data creation part for acquiring from the template storage part template data corresponding to an inputted character string extracted by the character string extraction part, and creating user operation record data, which records a user operation, based on the acquired template data and the inputted character string.

The application screen is formed from tree-structured data, which arranges multiple elements into a tree structure, and the element association part is able to associate a character string input element with an execution instruction element based on a structural relationship in the tree-structured data.

### BRIEF DESCRIPTION OF DRAWINGS

FIG. 1 is a block diagram showing an example of the configuration of a system related to an example.

FIG. 2 is a flowchart showing a process for analyzing a Web application.

FIG. 3 is a flowchart showing a process for detecting a monitoring-target button element and associating a text box element with this button element.

FIG. 4 is a flowchart showing the processing in a case where an event has been received.

FIG. 5 is a diagram showing an example of the configuration of a meaning database.

FIG. 6 is a diagram showing a pair comprising a text box and the meaning thereof, and an associated button.

FIG. 7 shows an example of the configuration of a format template for creating a user operation log.

FIG. 8 is a block diagram showing an example of the configuration of a system related to a second example.

FIG. 9 is a flowchart showing a process for analyzing a Web application.

FIG. 10 is a flowchart showing a process for analyzing the relationship between a target element and text existing therearound.

FIG. 11 is a flowchart showing a process for adding a button element event.

FIG. 12 is a block diagram showing an example of the configuration of a system related to a third example.

FIG. 13 shows an example of analysis-target data outputted from a Web application.

FIG. 14 is a flowchart showing an analysis of Web application communication.

FIG. 15 is a block diagram showing an example of the configuration of a system related to a fourth example.

FIG. 16 is a flowchart showing an analysis of Web application communications.

FIG. 17 is a block diagram showing an example of the configuration of a system related to a fifth example.

FIG. 18 is a flowchart showing an analysis of Web application communications.

FIG. 19 shows an example of a Web application screen.

FIG. 20 is a diagram illustrating a first HTML configuration of a Web application.

FIG. 21 is a diagram illustrating a second HTML configuration of a Web application.

FIG. 22 is a diagram illustrating a HTML document.

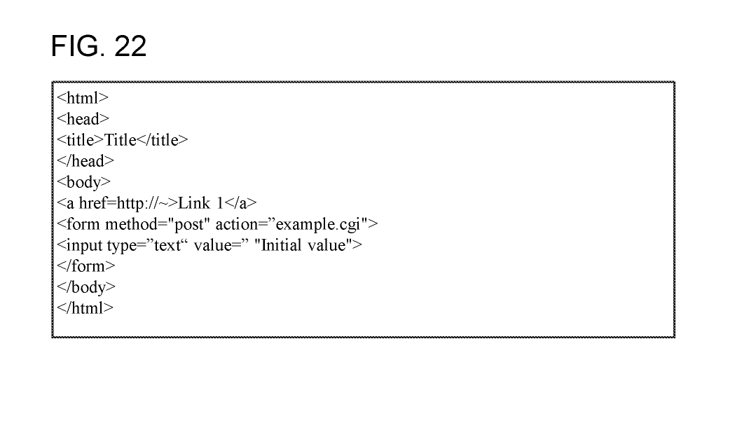

FIG. 23 is a diagram illustrating a DOM tree.

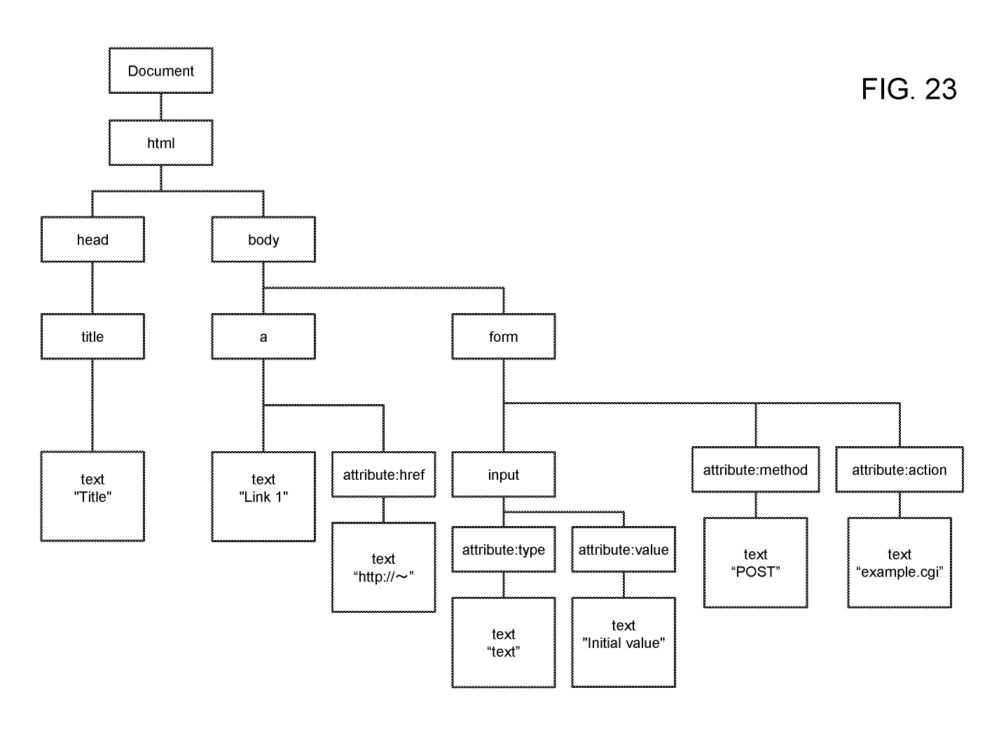

### DESCRIPTION OF EMBODIMENTS

An embodiment of the present invention will be explained hereinbelow by referring to the attached drawings. However, it should be noted that this embodiment is simply an example for realizing the present invention, and does not limit the technical scope of the present invention.

Furthermore, in the present specification, the information used in the embodiment is explained using the expression “aaa table”, but the present invention is not limited to this, and other expressions, such as “aaa list”, “aaa database”, and “aaa queue” may also be used. To show that the information used in this embodiment is not dependent on the data structure, this information may be called “aaa information”.

When explaining the content of the information used in this embodiment, the expressions “identification information”, “identifier”, “name” and “ID” are used, but these expressions are interchangeable.

In addition, in the explanations of the processing operations of this embodiment, a “computer program” or a “module” may be explained as the doer of the action (the subject). The program or module is executed by a microprocessor. The program or module executes the stipulated processing while making use of a memory and communication port (communication control device). Therefore, the processor may be read as the doer of the action (the subject).

Processing, which is disclosed as having a program or a module as the subject, may be read as processing performed by a management server or other such computer. In addition, either a portion or all of a computer program may be realized by dedicated hardware. The computer program may be installed in a computer in accordance with either a program delivery server or a storage medium.

### Example 1

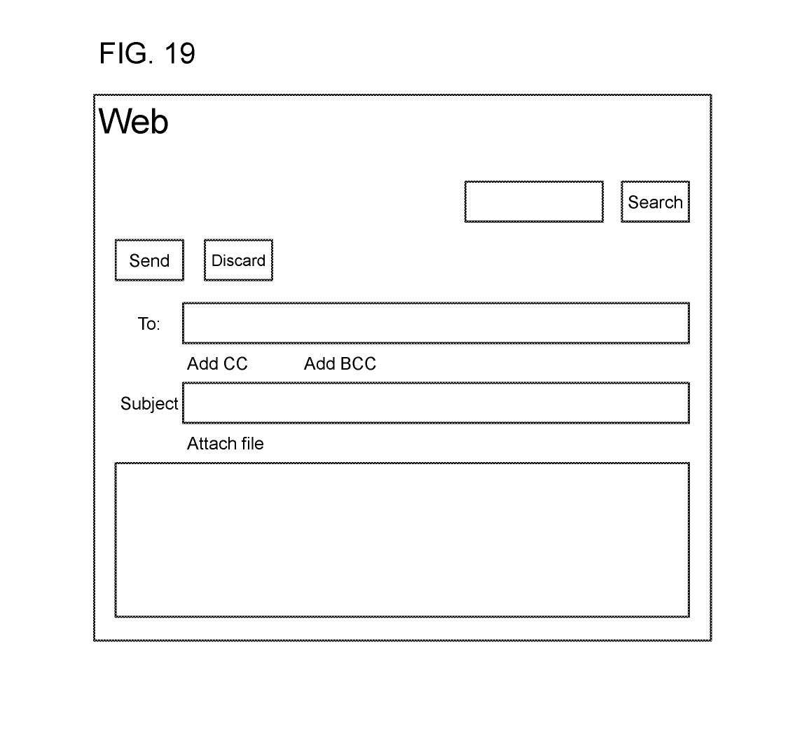

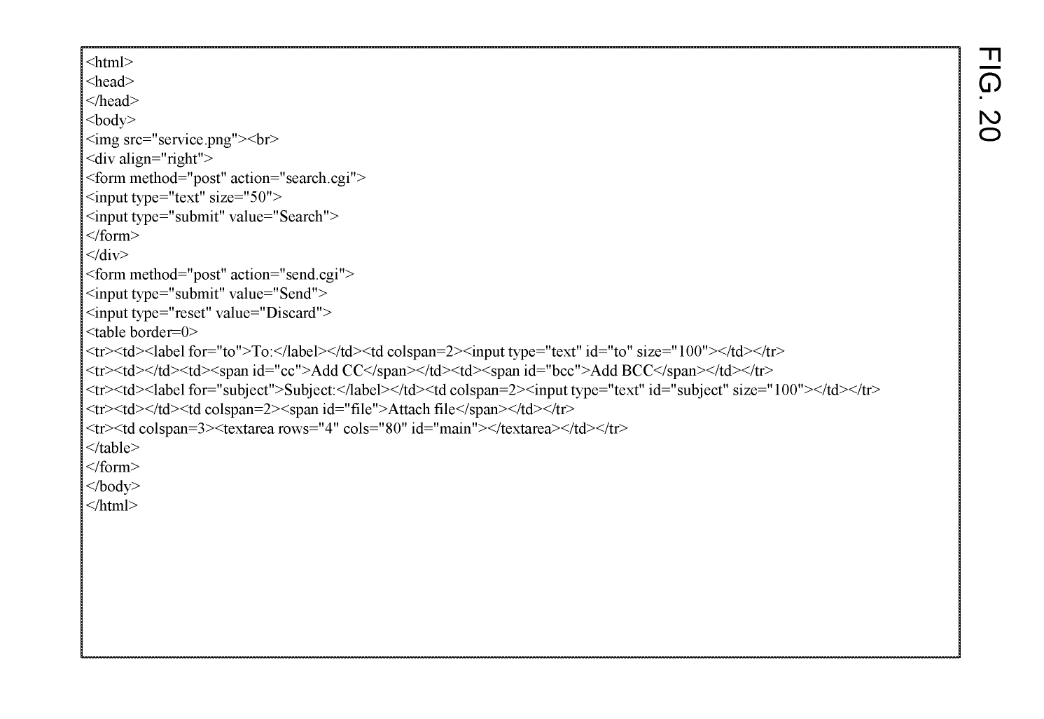

In this example, a Web application (FIG. 19), which has been configured using the HTML shown in FIG. 20, is supposed. In FIG. 20, a general form for HTML is described. The Web application of this example comprises multiple input boxes in a single form element, and, in addition, an execution element for sending the form. In this example, all the input boxes capable of being operated by the user exist in a single form element. These input boxes are acquisition-target elements in this system.

Specifically, the Web application of this example comprises an input box in which either an input element or a textarea element, which has “text” as a type attribute, exists as a form element nest. The user is able to operate on this input box. In addition, the Web application of this example comprises a form-send execution button, which exists as an input element having “submit” as the type attribute. However, the above explanation is for making the present invention easier to understand, and does not limit the scope of the present invention to the examples given above.

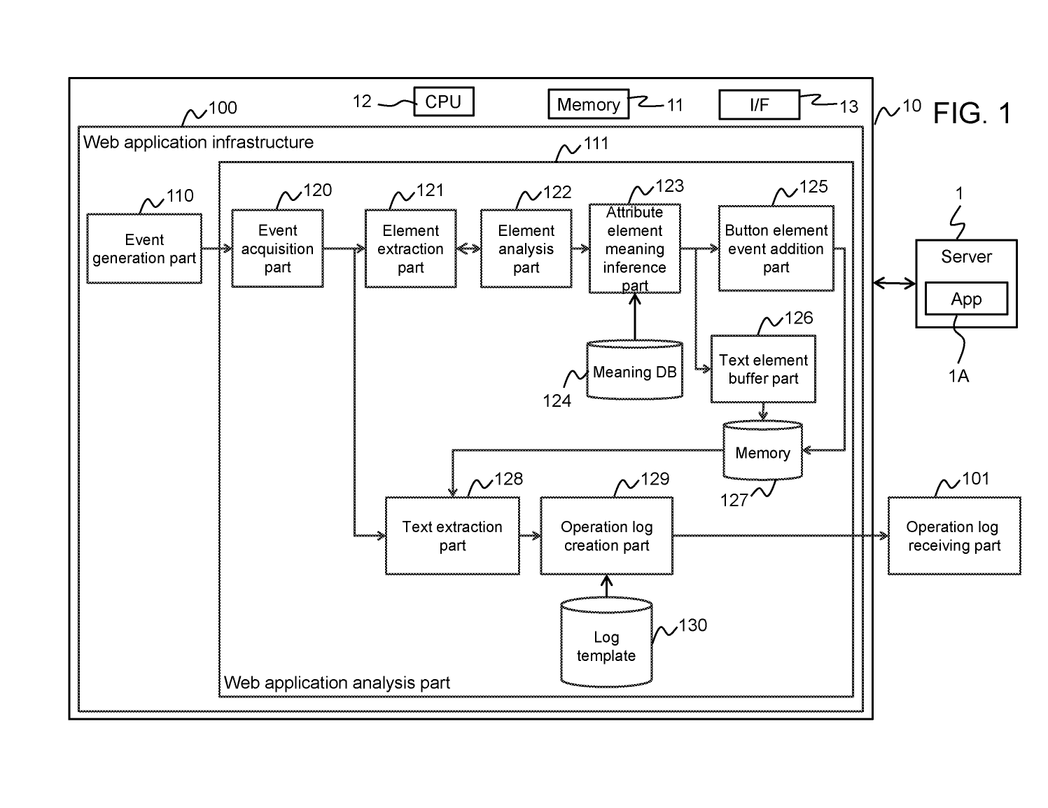

FIG. 1 is a block diagram showing a system for detecting and analyzing a user operation with respect to a Web application.

First of all, in the computer system to which this system is applied, a server 1 and a client terminal 10 are coupled via a communication network. The server 1, for example, comprises a Web application 1A, such as email software, document management software, a bulletin board, chat software, or teleconferencing software.

The client terminal 10, for example, is a computer terminal capable of using the Web application 1A, such as a personal computer, a tablet-type terminal, a mobile phone, or a personal digital assistant used by the user.

The client terminal 10 comprises a memory 11 for storing a computer program, a microprocessor (CPU) 12 for executing the computer program stored in the memory 11, and a communication interface 13 for carrying out communications with the server 1.

The microprocessor 12 reads and executes a prescribed computer program (a web browser) stored in the memory 11. In addition, the microprocessor 12 also executes the various types of software components implemented on the web browser.

The server 1, the client terminal 10, the memory 11, the microprocessor 12, and the communication interface 13 will be omitted from the drawings in other examples. The communication interface 13 function will be shown as a data communication control part 310, which will be explained further below.

A user operation detection system of this example comprises a Web application infrastructure 100 and an operation log receiving part 101, both of which will be explained below.

The Web application infrastructure 100, for example, is configured as a browser. The Web application infrastructure 100 of FIG. 1 is described to the extent necessary to understand and put the present invention into practice. In FIG. 1, a rendering engine for rendering a screen, a virtual machine for parsing and executing JavaScript code, and a server for developing the HTML into a tree structure to create a DOM tree have been omitted.

The operation log receiving part 101 receives a user operation log, which is created by an operation log creation part 129 to be described further below, from the operation log creation part 129. In this example, the method for implementing the operation log receiving part 101 is not limited. The operation log receiving part 101, for example, may be configured as software, which runs on the same terminal as the Web application infrastructure 100, may be configured as software, which runs on a different terminal, and, in addition, may be configured as a hardware device. For example, the operation log receiving part 101 may be disposed in a manager-used computer terminal for managing a user, and may be disposed in a management server for managing user operations.

In a case where the system shown in this example is a portion of a client terminal monitoring system or the like, the operation log receiving part 101 will probably adopt a procedure for sending a received user operation log to the manager of the client terminal.

The Web application infrastructure 100, for example, comprises an event generation part 110 and a Web application analysis part 111.

The event generation part 110 generates various events, and notifies the Web application analysis part 111 of the event information. The Web application infrastructure 100 can generally add a function. This function addition, for example, is referred to by a name, such as extension function, add on, add in, or extension. Hereinafter, the function addition will be described as an extension function.

When implementing the Web application analysis function 111 on a browser or the like as an extension function, the event generation part 110 notifies the Web application analysis part 111 of an event, which is generated at various times. The various times, for example, are when a read of a Web application resource starts, when a read of all the resources of the Web application has been completed, and when the Web application rendering has been completed and the user operates a mouse or a keyboard on the application screen. The timing of the generation of a mouse operation-based event, for example, is further divided into when the mouse button has been pressed, and when the pressed mouse button has been released.

The Web application analysis part 111, for example, comprises an event acquisition part 120, an element extraction part 121, an element analysis part 122, an attribute element meaning inference part 123, a meaning DB 124, a button element event addition part 125, a text element buffer part 126, a temporary memory 127, a text extraction part 128, an operation log creation part 129, and a log template 130. In this example, the Web application analysis part 111 is implemented as an extension function, but this is to facilitate the explanation, and does not limit the implementation method of the present invention.

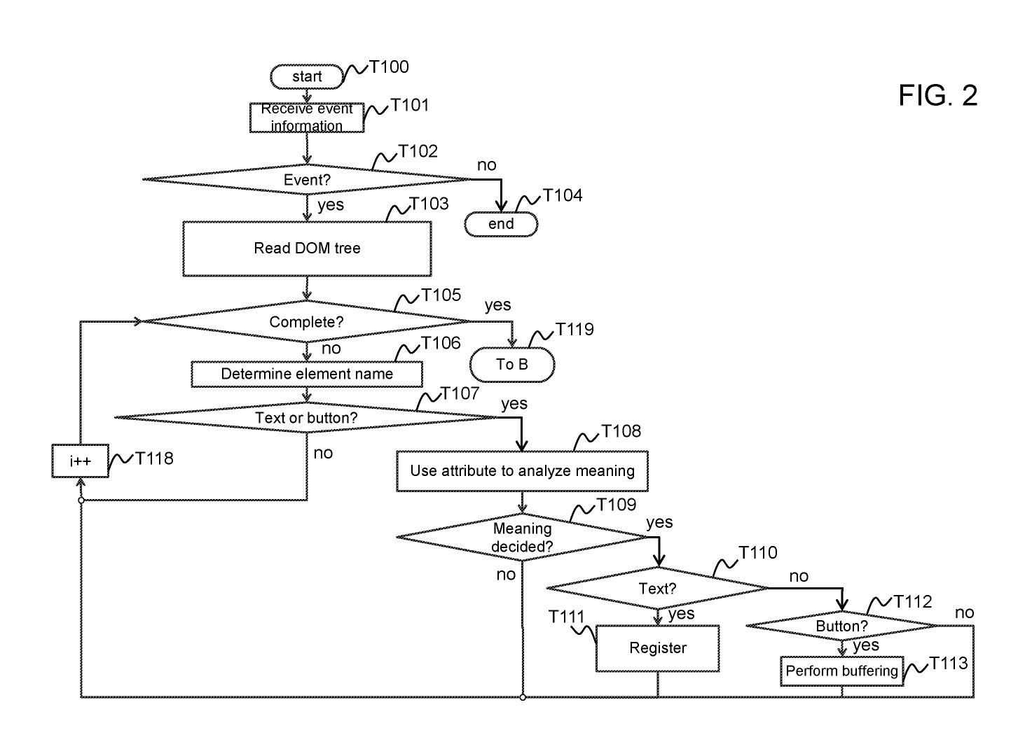

The respective internal functions of the Web application analysis part 111 will be explained by referring to FIGS. 2 through 4.

FIG. 2 is a flowchart showing a process for analyzing the Web application. In FIG. 2, the event acquisition part 120 receives event information notified from the event generation part 110 and determines the type of event (T101). The event acquisition part 120 determines whether or not the event should be received (T102). In a case where it is not an event, which should be received (T102: NO), this processing ends.

In this example, it is supposed that the event acquisition part 120 only acquires an event, which is generated when the reading of all the resources comprising the Web application has been completed (this event generation is an example of a first timing), and an event, which is generated when a specified element has been selected using either a mouse or a keyboard (this event generation is an example of a second timing). However, this limitation is for facilitating the explanation, and does not limit the scope of the present invention.

The operation in a case where the event acquisition part 120 has received an event generated when the reading of all the resources comprising the Web application has been completed will be explained below.

The element extraction part 121 reads a DOM tree of the Web application (T103). In a case where the Web application analysis part 111 is implemented as an extension function, it is possible to access this DOM tree.

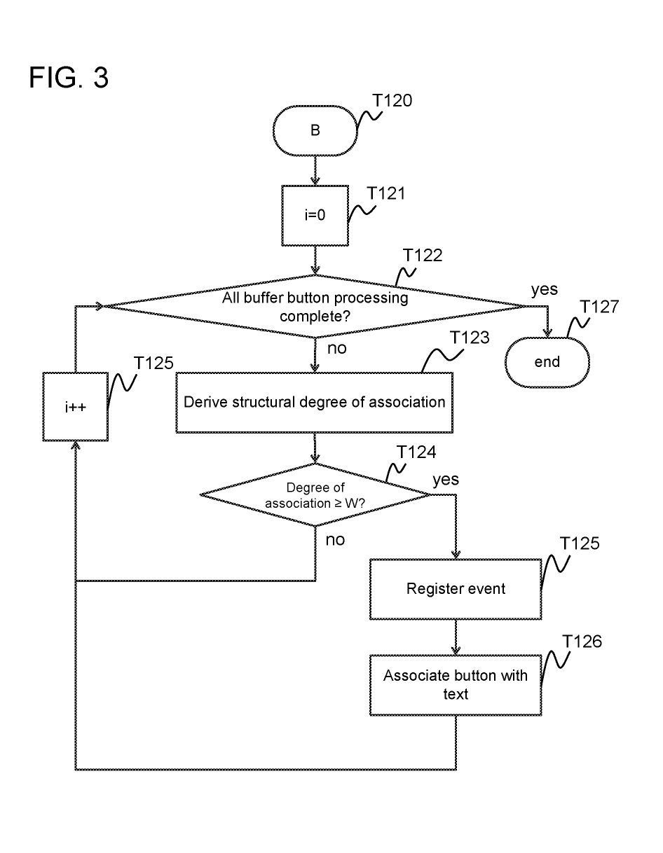

Next, the element extraction part 121 initializes i, which is a temporary variable for loop processing (T103), and retrieves all the elements of the DOM tree. The element extraction part 121 increments the loop variable i (T118) while transferring the elements in the DOM tree one at a time to the element analysis part 122 (T105). This loop process is repeated until the element extraction part 121 has transferred all of the elements to the element analysis part 122 (T105: YES). After this loop processing ends, the processing advances to process B, which will be explained further below using FIG. 3 (T119).

The element analysis part 122 analyzes the element name and attribute of an element provided by the element extraction part 121 (T106). The element analysis part 122 together with the element extraction part 121 comprises an example of a “first element extraction part”.

Specifically, the element analysis part 122 extracts an element comprising a text box for a user to input text, and a button element, which the user can select via either a click operation or by inputting Enter from a keyboard (T106), and transfers these extracted elements to the attribute element meaning inference part 123 (T107).

The text box element, which is an example of a “character string input element”, for example, is specified by either an element for which the element name is input and the type attribute is text, or a textarea element. The button element, which is an example of an “execution instruction element”, is specified by either an element for which the element name is input and the type attribute is submit, reset, or button, or an element for which the element name is button.

In this example, the element analysis part 122 does not transfer an input element having the type attribute “reset” to the attribute element meaning inference part 123. This is because a button element having the type attribute “reset” is a button for cancelling the sending of data, which has been inputted to the Web application, to the server providing the Web application. In this example, since the data to be sent to the server providing the Web application is monitored, the element analysis part 122 does not transfer a button element having the type attribute “reset” to the attribute element meaning inference part 123.

An example in which a text box element and a button element are the target elements has been described, but this is to facilitate the explanation, and another element may serve as the analysis target.

The element analysis part 122 returns the analysis result to the element extraction part 121. This analysis result is true in a case where the target element is a text box element or a button element, and is false otherwise. The element extraction part 121 receives the result of the analysis by the element analysis part 122, and when this result is false, transitions the processing to the next element (T107: NO).

In a case where the target element is either a text box element or a button element (T107: YES), the element analysis part 122 transfers this element to the attribute element meaning inference part 123.

The attribute element meaning inferences part 123, which is an example of either the “role inference part” or a “first role inference part”, infers the meaning (role) of the element based on the attribute of the element received from the element analysis part 122 (T108). Specifically, the attribute element meaning inferences part 123 references a keyword-meaning pair stored in the meaning database 124, finds a keyword, which matches the attribute value specified in the attribute, and as a result of this, obtains a meaning corresponding to the attribute value specified in the attribute, and a certainty factor therefor (T108). As the attributes to be referenced, such generally used attributes as id, name, class, value, and so forth can cited.

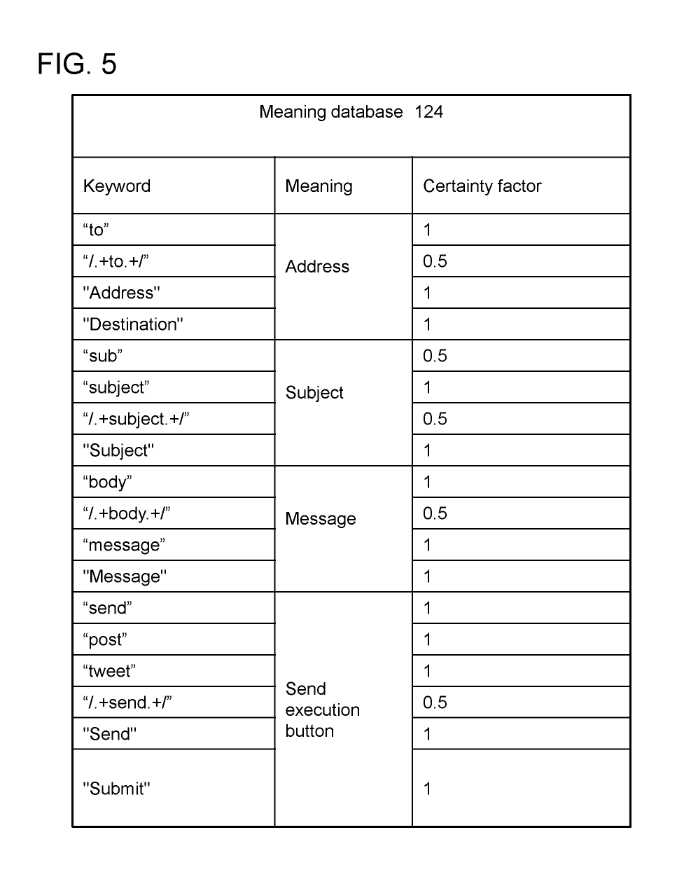

The meaning database (DB) 124 shown in FIG. 5 will be explained. The meaning DB 124 is an example of the “role database”. According to FIG. 5, in a case where the attribute value of the id attribute of a certain text box element is “to”, the meaning of this text box element is “address”, and the certainty factor is “1”.

In a case where the attribute value of the value attribute of a certain button element is “quxsend”, the meaning of this button element is “send execution button”, and the certainty factor is “0.5”. In FIG. 5, the “/.+to.+/” shown in the second row is written using a regular expression format. This is to facilitate the explanation, and does not limit the meaning DB 124 implementation method, and particularly the keyword expression method.

In FIG. 5, only in a case where the keyword itself is almost synonymous with the “meaning” is the certainty factor thereof given as 1. Since this example uses general-purpose attributes and infers the meaning, this valuation is used to improve the probability of the meaning inference. The certainty factor of the meaning DB 124 does not have to be determined to be a value of either “1” or “0.5” as explained above, but rather may be configured to values other than these. The configuration may also be such that either the manager revises the certainty factor manually, or the certainty factor is adjusted automatically.

In the meaning DB 124, only a character string related to a monitoring target may be prepared as a key. That is, in the monitoring-target Web application, only a character string related to either a text box element or a button element, which one wishes to monitor, may be used as a key and registered in the meaning DB 124. Therefore, the size of the meaning DB 124 can be kept small compared to a DB, which stores a wide-range of addresses and names as described in the prior art.

The attribute element meaning inference part 123 determines that the meaning has been decided in a case where the certainty factor of the acquired meaning is equal to or larger than a prescribed value a (at least 0 and not more than 1), and transfers the target element to either the text element buffer part 126 or the button element event addition part 125 (T109). The attribute element meaning inference part 123 transfers the target element to the text element buffer part 126 in a case where the target element is a text box element (T110), and transfers the target element to the button element event addition part 125 in a case where the target element is a button element (T112), respectively.

The text element buffer part 126 confirms that the element transferred from the attribute element meaning inference part 123 is a text box element (T110: YES), combines this text box element with the meaning derived by the attribute element meaning inference part 123, and registers this pair in the temporary memory 127 (T111).

The button element event addition part 125, which is an example of the “element meaning association part”, confirms that the element transferred from the attribute element meaning inference part 123 is a button element (T112: YES), and buffers this button element (T113).

The operation of the button element event addition part 125 will be explained by referring to FIG. 3. When processing starts (T120), the button element event addition part 125 first initializes the loop variable i (T121).

Next, the button element event addition part 125 executes loop internal processing for all the button elements, which were buffered in Step T113 of FIG. 2 (S122). In the loop process, the button element event addition part 125 increments the variable i (T125), and when the loop has been completed for all the buffered button elements (T122: YES), ends this processing (T127).

The loop internal processing of the button element event addition part 125 will be explained. The button element event addition part 125 derives a structural degree of association for the target button element (T123). In a case where the degree of association derived in Step T123 is equal to or larger than a prescribed quantitative value W (T124: YES), the button element event addition part 125 performs a registration so as to acquire this button element as an event in accordance with either a mouse or a keyboard (T125).

In addition, the button element event addition part 125 associates the relevant button element with a set of text box elements possessing a degree of association with the button element registered in Step T125 (T126).

The structural degree of association of the button element shows the degree of association with the set of text box elements, which was buffered in Step T111. In the case of the Web application targeted in this example, the button element degree of association is derived in accordance with whether the button element belongs to the same form element as the set of text box elements buffered in Step T111.

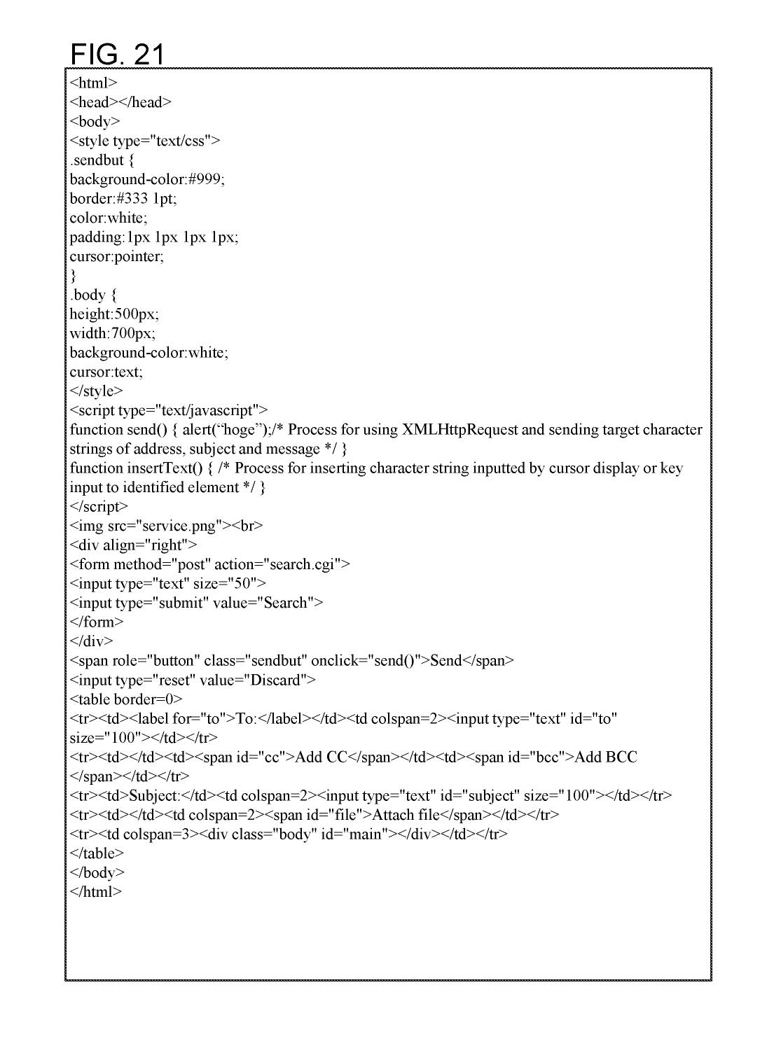

As an example, the degree of association can be derived as follows. In FIG. 21, a “search” button is compared to a set of text box elements for inputting an email address, a subject, or a message. Since the “search” button belongs to a different form element than the above set of text box elements, the degree of association can be configured as “0”.

Alternatively, since the “send” button belongs to the same form element as the above text box element set, the degree of association thereof can be configured to “1”. When W=1 here, the button element comprising the “send” button is the trigger for sending the data, which has been inputted to the above text box elements.

Therefore, the button element event addition part 125 performs an event registration for a button element having a degree of association of equal to or larger than the prescribed value W (T125), and associates the relevant button element with the set of text box elements related to this button element (T126).

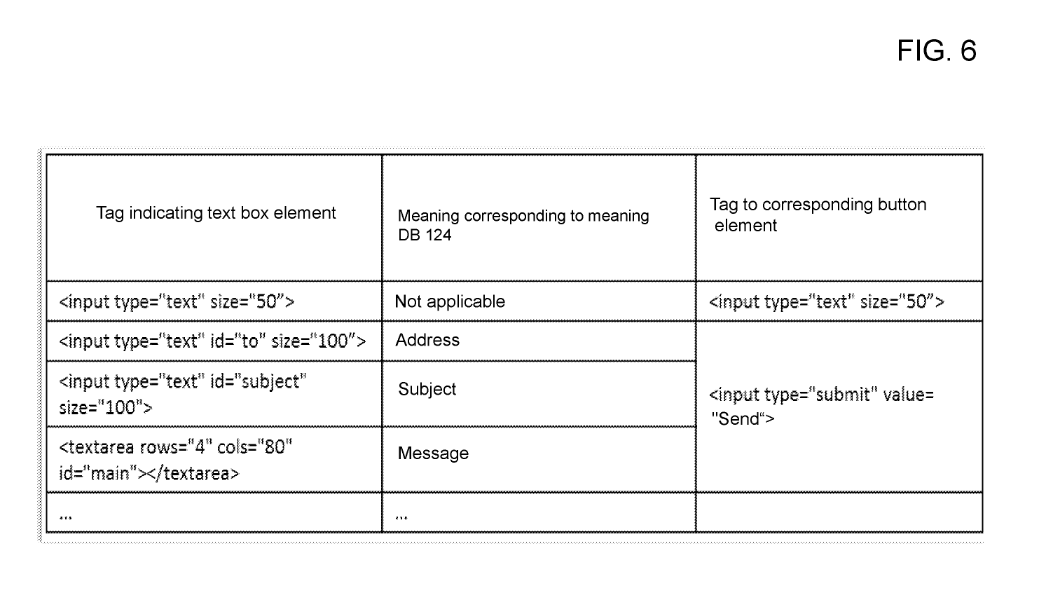

The method for associating the button element with the text box elements in Step T126, and the method of storing this association are not particularly limited. A visual example of the elements stored in the temporary memory 127 in accordance with the above-described processing in the Web application of FIG. 20 is shown in FIG. 6.

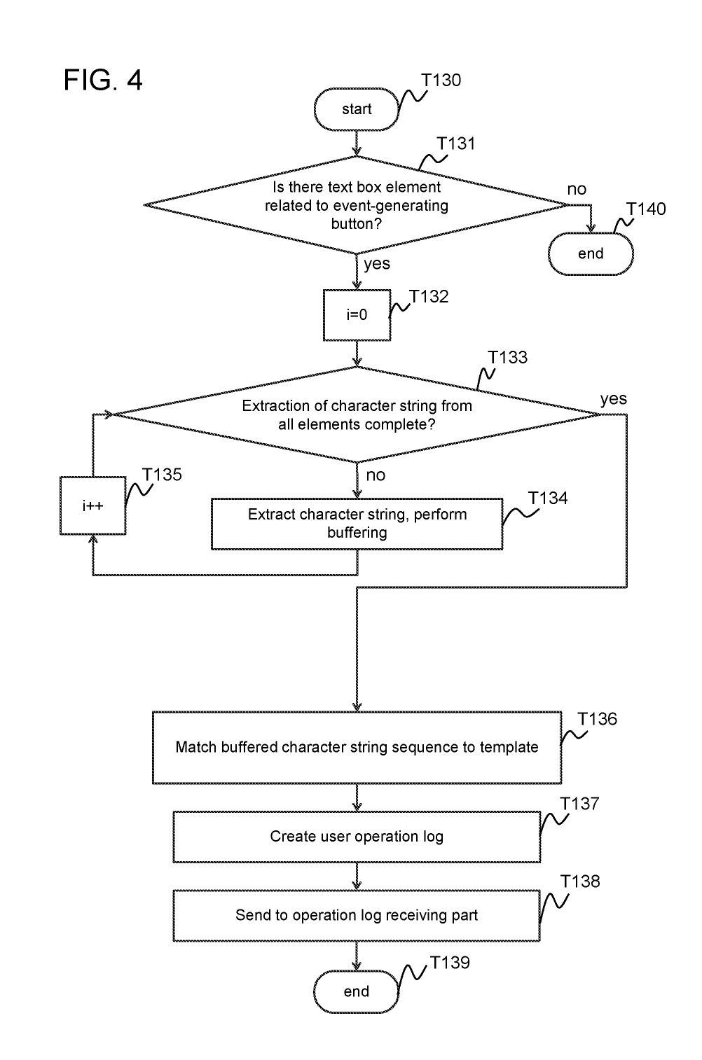

Next, the operations at the time the event acquisition part 120 has received an event when a specified element has been selected using either a mouse or a keyboard will be explained using FIG. 4. An event at the time that a specified element has been selected using either a mouse or a keyboard is generated when the button element registered in the above-described Step T125 has been selected. That is, this type of event signifies an event generated in either a case where the registered button element has been clicked on using a mouse, or a case where the Enter key has been pressed in a state in which the registered button element was selected via a keyboard.

The text extraction part 128, which is an example of the “character string extraction part”, extracts text from all the text box elements in the set of text box elements registered in Step T111 for which there is a degree of association with the event-generating button element (T130 through T135).

The event-generating button element may be called the button element constituting the target of the generated event, that is, the generated event-target button element. The generated event-target button element, for example, is the button element, which is a monitoring target being monitored because a prescribed event (an event generated at the time of a mouse operation) was generated. Therefore, this button element can also be called the monitoring-target button element.

The text extraction part 128 checks for the presence or absence of a text box element related to the generated event-target button element (T131). In a case where a text box element related to the generated event-target button element does not exist (T131: NO), the text extraction part 128 ends this processing (T140).

In a case where a text box element related to the generated event-target button element exists (T131: YES), the text extraction part 128 initializes the loop variable i (T132), and extracts the user-inputted character strings from all the associated text box elements (T134). The text extraction part 128 increments the loop variable i as needed when a character string is extracted from each text box element (T135).

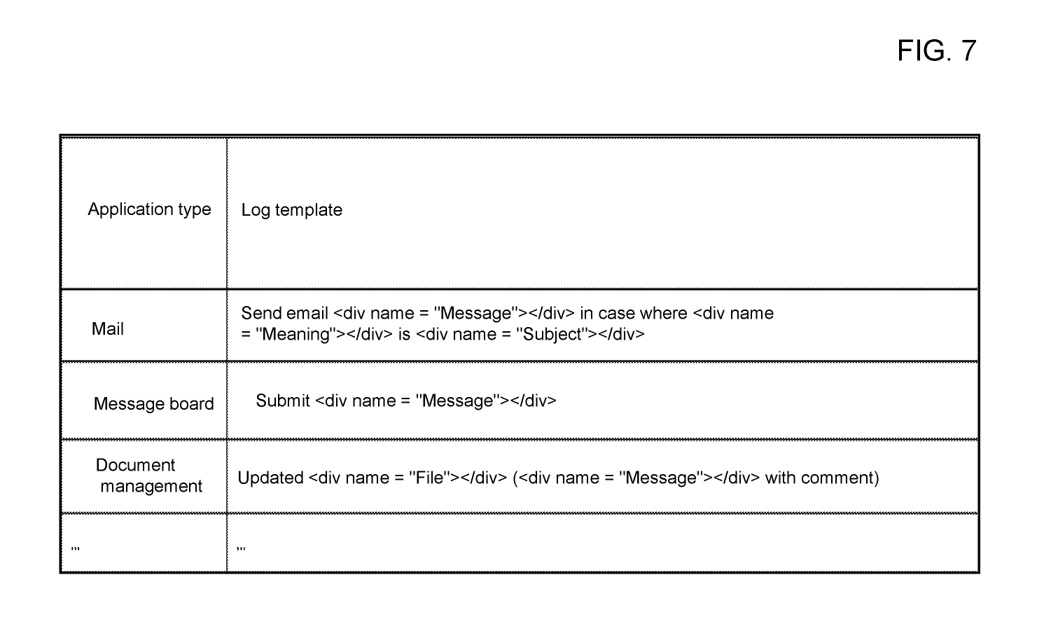

The operation log creation part 129, which is an example of the “user operation record data creation part”, creates a log of user operations using a template corresponding to a character strings from the log template 130, which is an example of the “template storage part” (T136, T137). An example of the log template is shown in FIG. 7, although any means of expression may be used. According to FIG. 7, in the case of a mail-related operation log, the operation log is configured using empty character strings (<div name=“meaning”></div>) enabling the input of an address, a subject and a message, and a character string linking these empty character strings.

The operation log creation part 129 can connect a text box element with a degree of association with the generated event-target button element to each empty character string of the log template 130 by collating the “meaning corresponding to the meaning DB 124” item (FIG. 6) of each item stored in the temporary memory 127 to the value specified in the name attribute of the empty character string (FIG. 7).

An example of the creation of an operation log by the operation log creation part 129 will be explained. First, the operation log creation part 129 must determine which template is the best match for the set of text box elements having a degree of association with the generated event-target button element (T136).

An example of a match determination method will be explained. A number not in the empty character string of each template is treated as Nf. A number of text box elements having a degree of association with a surplus event generated-target button element with respect to each template is treated as Nr. The operation log creation part 129 uses a template for which the total value of Nf+Nr is the smallest. The total value of Nf+Nr is an example of “degree of conformity”.

The text extraction part 128 has acquired a character string as an address (a mail address), a character string as a subject, and a character string as a message in the processing described above (T131 through T135). In accordance with this, for the mail template, since Nf=0 and Nr=0, Nf+Nr=0. Similarly, for the message template, since Nf=0 and Nr=2, Nf+Nr=2. In addition, for the document management template, since Nf=1 and Nr=2, Nf+Nr=3.

As a result, it is clear that the mail template is the best match for the buffered character string. Accordingly, the operation log creation part 129 inserts the text of the text box element having a degree of association with the generated event-target button element corresponding to each mail template empty character string, and creates an operation log (T137). Lastly, the operation log creation part 129 sends the created operation log to the operation log receiving part 101 (T138) and ends this processing (T139).

The result of the log template matching may be attached to the operation log. For example, the total value of Nf+Nr may be included in the operation log, or may be sent together with the operation log.

In this example, the processing required to acquire an operation log is performed after receiving each event in order to facilitate the explanations of the operation at the time the event acquisition part 120 has received an event generated when the read of all the resources comprising the Web application has been completed, and the operation at the time the event acquisition part 120 has received an event generated when a specified element has been selected using either a mouse or a keyboard.

The following method may be used instead of the method described above. That is, in a case where the event acquisition part 120 has received an event generated when the read of all the resources comprising the Web application has been completed, all of the resources comprising this Web application are buffered. Then, in a case where the event acquisition part 120 has received an event generated when a specified element has been selected using either a mouse or a keyboard, the text required to create the operation log is acquired.

According to this method, it is possible to carry out the above-described operation log acquisition processing at a different time from when an event has been received. This method, for example, is effective when acquiring a log of user operations on a Web application for a client terminal, which only has a powerless CPU.

In this example, in order to facilitate the explanation, an example for implementing a Web application analysis part 111 was given as an extension function provided to the Web application infrastructure 100. Instead, for example, the configuration may be such that a monitoring apparatus is arranged on the communication channel between the client and the server, and this monitoring apparatus monitors the log of user operations on the Web application. That is, this monitoring apparatus comprises the same Web application configuration capabilities as the Web application infrastructure 100, and monitors all the request data and response data exchanged between the client and the server. This makes it possible for the monitoring apparatus to have the same monitoring performance as this example.

According to the example, which has been described in detail hereinabove, either the purpose or meaning of an element is obtained based on the general-purpose attribute possessed by the relevant element, and the degree of association between an extracted set of text box elements and a separately extracted button element is derived. Then, in this example, the main purpose of the Web application is inferred from multiple elements and the meanings thereof, and a character string, which the user has inputted to a text box element, can be acquired at an appropriate timing, and lastly, a log of the user's operation on the Web application can be acquired.

### Example 2

A second example will be explained. The below explanation will focus on the differences with the first example. In this example, a Web application (FIG. 19) configured using the HTML of FIG. 21 is assumed. FIG. 21 does not execute a form-send using a form element as shown in FIG. 20. In FIG. 21, an input box for inputting either the address or the subject is configured using either input or textarea, which are text box elements. However, the input box for inputting the message is configured using a div element.

Actually, a portion of the Web application uses the div element and the like to realize high-level processing, which cannot be realized with either the input or textarea elements, which are text box elements. For example, in a case where a message is to be written using rich text expressions, the text box is realized using the div element and innerHTML. The div element is an HTML element for handling a range of data enclosed by the div element as a single group. The innerHTML is used in a case where the content of an identified HTML element is to be collectively rewritten.

A detailed description is omitted in FIG. 21, but when a click on the div element comprising the input box for inputting the message is detected, various processing is realized using JavaScript codes. The various processing includes a process for detecting a character string inputted in the past and the clicked location, and displaying a blinking cursor. As another example, a key-up event is monitored, a target-key character is inputted when the key-up event is generated, in a case where this character must be converted to Japanese, a kanji or other such character string, which is an IME (Input Method Editor) output, is detected, and this character string is inserted in the div element.

In FIG. 21, similar to the text box element, the form-send button is not configured using the input element for submitting a form-send. An original form-send button is designed in accordance with the div element by applying the button-visible style. A style sheet is an example of “design data”.

A portion of the Web application uses a configuration like this to freely design a button. A detailed description is omitted in FIG. 21, but when the div element, which is the button element, is clicked, each character string, which has been inputted to the elements comprising the address, the subject, and the message, the ids of which are “to”, “subject”, and “main”, are acquired, and form data is formed. Then, a form-send is executed using the JavaScript asynchronous communication library XMLHttpRequest.

The configuration of FIG. 20 can be cited as another example of arranging an original button like this. As shown in FIG. 20, a text box element is arranged inside the form element, an element, which is a send execution button, is concealed, and arranged as an element. A pseudo send execution button is created instead using either a div element or a general-purpose button (<button type=“button”></button>). When the pseudo send execution button is clicked, JavaScript codes control the process so that the concealed real send execution button is clicked.

The example of FIG. 20 and the example of FIG. 21 are for facilitating the explanation of this example, and do not limit the scope of the present invention.

The Web application of this example does not use the standardized form element to configure a form. This is to increase the Web application's degree of freedom. The Web application of this example comprises an input-target element, which makes a user input possible, or makes the user believe that an input is possible. In addition, the Web application of this example comprises a button, or an element, which the user believes is a button, for the user to request that the Web application-providing server send a character string, which has been inputted to the input-target element.

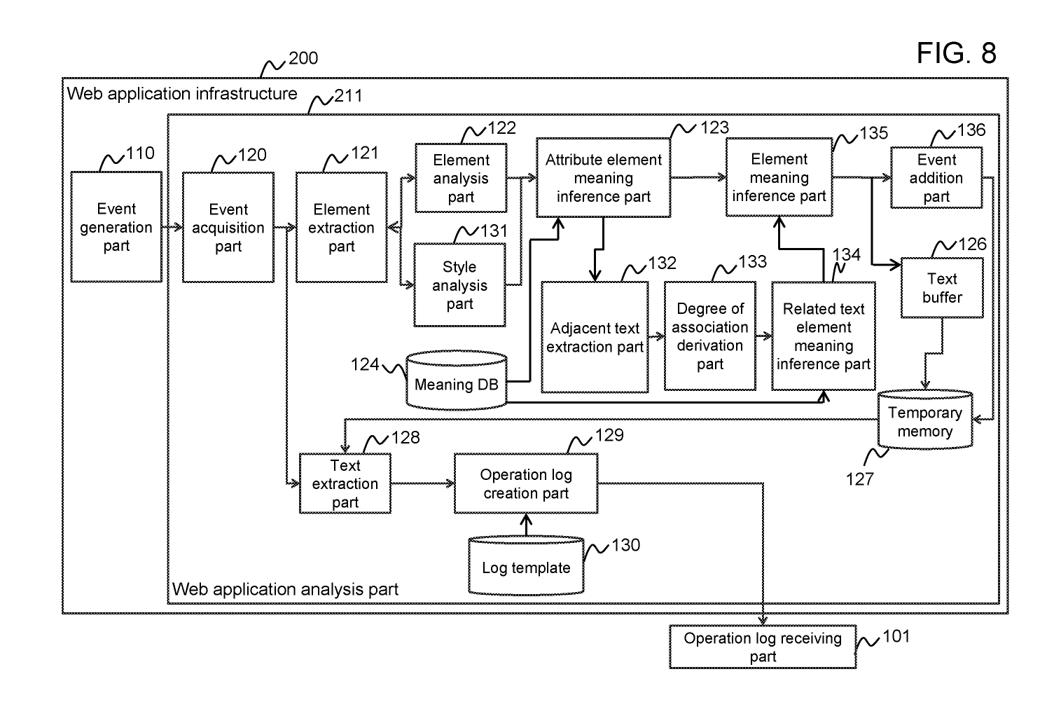

FIG. 8 is a block diagram showing a Web application analysis system related to this example. A Web application infrastructure 200 comprises the event generation part 110 and a Web application analysis part 211.

Compared to the Web application infrastructure 100, the Web application infrastructure 200 differs in that the Web application analysis part 111 has changed to the Web application analysis part 211.

The Web application analysis part 211 of this example comprises the event acquisition part 120, the element extraction part 121, the element analysis part 122, the attribute element meaning inference part 123, the meaning DB 124, the text element buffer part 126, the temporary memory 127, the text extraction part 128, the operation log creation part 129, and the log template 130. In addition, the Web application analysis part 211 of this example comprises a style analysis part 131, an adjacent text extraction part 132, a degree of association derivation part 133, an associated text element meaning inference part 134, an element meaning inference part 135, and a button element event addition part 136 in place of the button element event addition part 125.

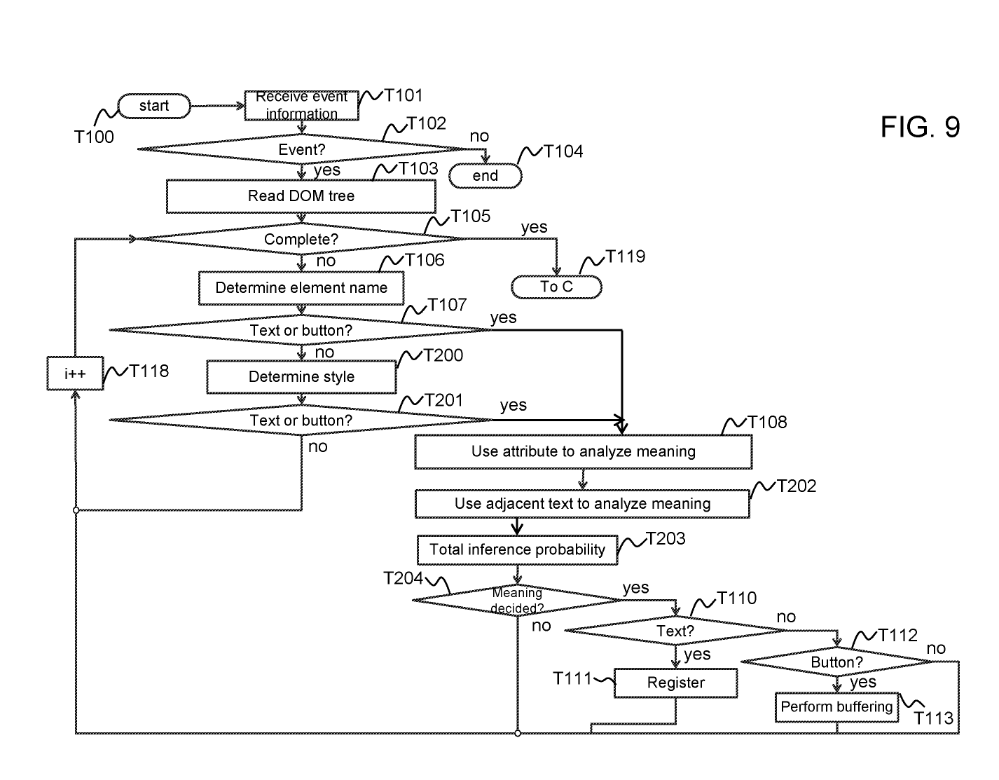

Each component in the Web application analysis part 211 of FIG. 8 will be explained below using FIGS. 9 through 11.

FIG. 9 is a flowchart of Web application analysis processing. In a case where the processing of Steps T100 through T107 has been completed, and the result of Step T107 is false (T107: NO), the style analysis part 131 determines the element, which uses style (T200).

An example of a criterion for determining that a target element is a text box element will be explained. The fact that conditions, such as the cursor property of the target element being “text”, and a value, which is the same as that of another text box element, having been specified for a background-color property in the style sheet has been satisfied may be used as the criterion for determining that the target element is a text box element. In addition, a determination that the target element is a text box element may be made in a case where either one of the above-mentioned two conditions has been met, and a determination that the target element is a text box element may be made in a case where both of the above-mentioned two conditions have been met.

Examples of criteria for determining that the target element is a button element will be explained. Conditions, such as the cursor property of the target element being any of “auto”, “default”, or “pointer”, a general-purpose element, which is used generically as either a div element or a span element, having at a depth of 1, that is, directly possessing a text node type element, an a element, which is capable of attaching an anchor where one does not exist between character strings, possessing a text node type element at a depth of 1, and the specifying of a button-visible style in the style sheet can be cited. The specification of a button-visible style, specifically, is the use of a dark color in the border property with respect to the background-color property of the target element. A determination that the target element is a button element may be made in a case where any one of these conditions has been satisfied, and a determination that the target element is a button element may be made in a case where either multiple conditions or all of the conditions have been satisfied.

The style analysis part 131 can be configured together with the element extraction part 121 as an example of a “second element extraction part”. The style analysis part 131, in a case where the result of the above-mentioned determination is true (T201: YES), transfers the target element to the attribute element meaning inference part 123 (to T108), and in a case where the determination result is false (T201: NO), returns the result to the element extraction part 121 (to T118).

The attribute element meaning inference part 123 carries out Step T108, and transfers the certainty factor derived in Step T108 to the element meaning inference part 135. Hereinafter, the certainty factor derived in accordance with the attribute element meaning inference part 123 will be written as inferred probability Pa. This inferred probability Pa is derived for each target element, and as such, is written together with an index thereof. Therefore, the inferred probability derived by the attribute element meaning inference part 123 for a certain target element n is written as Pan.

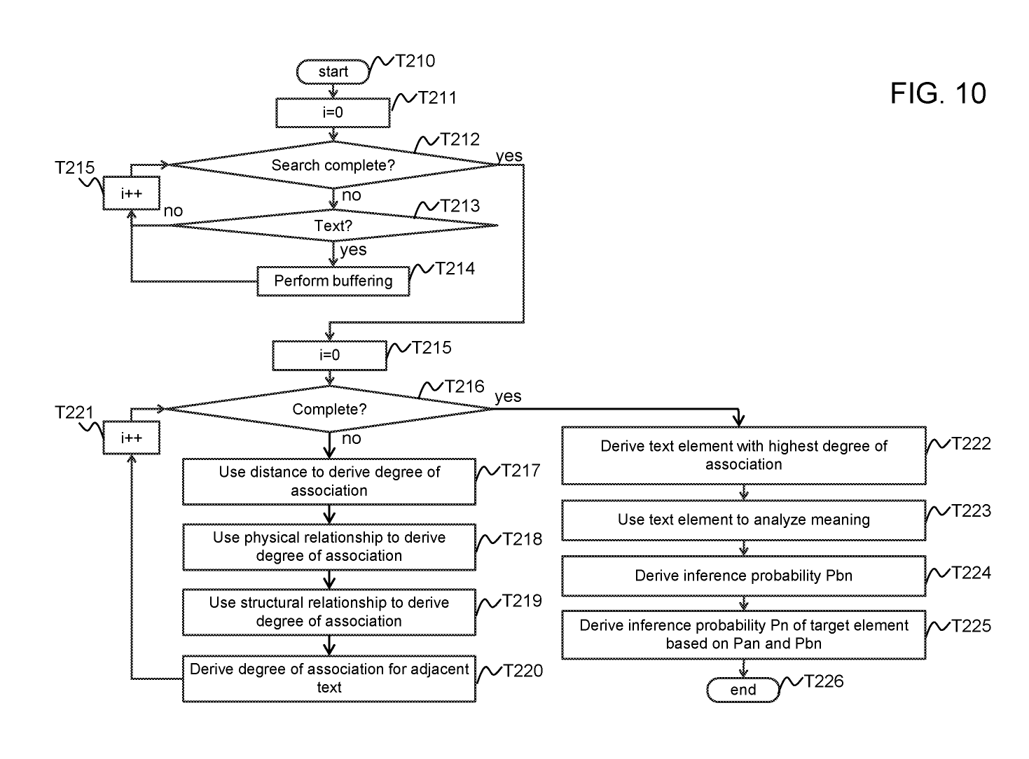

To perform meaning analysis using an adjacent text, the attribute element meaning inference part 123 transfers the target element to the adjacent text extraction part 132 (T202) and totals the inferred probabilities (T203). Meaning analysis using the adjacent text will be explained further below using FIG. 10.

In a case where the meaning of the target element has been decided (T204: YES), the attribute element meaning inference part 123 carries out Step T110 and beyond, and in a case where the meaning has not been decided (T204: NO), ends the meaning inference processing for the target element.

The operations of the adjacent text extraction part 132, the degree of association derivation part 133, the associated text element meaning inference part 134, and the element meaning inference part 135, that is, the operation of Step T202 of FIG. 9, will be explained in detail using FIG. 10. The adjacent text extraction part 132, the degree of association derivation part 133, and the associated text element meaning inference part 134 are configured as examples of the “second role inference part”. The element meaning inference part 135, for example, may be described as “a final role determination part for making a final determination as to the role of an inference-target element based on the inference result of the first role inference part and the inference result of the second role inference part”.

When the target element is transferred from the attribute element meaning inference part 123 (T210), the adjacent text extraction part 132 initializes i, which is the loop variable (T211), and searches for a neighboring text (also called an adjacent text) existing within a distance S from the target element (T212).

The distance S, for example, has an intermodal movement in a DOM tree as a basic unit. In a case where elements are separated by two nodes, the distance S is “2”. The distance S may be defined by rendering only the HTML in the vicinity of the target element, and treating one pixel on an X-Y coordinates image as the basic unit. In a case where elements are separated by three pixels, the distance S will be “3”. The distance S may be defined using either method.

The adjacent text extraction part 132, in a case where the search-target node is text node (T213: YES), buffers this text node (T214). The operations of Steps T212, T213, and T214 are repeated for the set of nodes within the distance S (T215). When the search for the text existing within the distance S is complete (T212: YES), the adjacent text extraction part 132 transfers the text node array buffered in Step T214 to the degree of association derivation part 133 in order to proceed to the next step. The text node existing within the distance S is an example of a “prescribed associated element”.

The degree of association derivation part 133 initializes the i, which is the loop variable (T215), and derives the respective degrees of association for all the elements in the text node array buffered in Step T214 (T216).

The degree of association between the target element and the adjacent text node, for example, is derived based on the distance between the two (T217), the physical relationship between the two (T218), or the structural relationship between the two (T219).

Examples of derivation methods based on the multiple indices of distance, physical relationship, and structural relationship between the target element and the adjacent text node will be explained further below, but the present invention is not limited to these methods. The relative merits of the degrees of association calculated from each of the multiple indices do not particularly matter. In addition, the computation sequence, i.e., which index is used to compute the degree of association first, does not particularly matter.

An example of deriving the distance between the target element and the adjacent text node will be explained. As described hereinabove, the distance may be calculated by using an intermodal movement in the DOM tree as the basic unit, or an image may be acquired by rendering only the vicinity of the target element and adjacent text node and the distance may be calculated using one pixel of the X-Y coordinates of this image as the basic unit.

In FIG. 21, in a case where the element for inputting the address “<input type=“text” id=“to” size=“100”>” is used as the target element, when the method which uses the intermodal movement as one unit is used, the distance to “To:” is 4, the distance to “add CC” is 6, and the distance to “add BCC” is 6.

In a case where the “subject:” shown towards the bottom of FIG. 21 is an efficient node movement, the distance is 5, and as such, an inefficient distance measurement is preferred.

Specifically, when moving between nodes from the element for inputting the address “<input type=“text” id=“to” size=“100”>” to the “subject:”, a linear search passes through the element set storing “add CC” and “add BCC” “<tr><td></td><td><span id=“cc”>add CC</span></td><td><span id=“bcc”>add BCC</span></td></tr>”.

When this movement distance is also taken into account, the distance from the element for inputting the address “<input type=“text” id=“to” size=“100”>” to the “subject:” becomes 19. The distances to the “To:”, the “add CC” and the “add BCC” also change, but these distances are shorter than the distance to the “subject:”.

An example of deriving the physical relationship between the target element and the adjacent text node will be explained. The meaning of the physical relationship between the target element and the adjacent text node will differ in accordance with the language used in the Web application.

For example, in the case of a language in which sentences are written from left to right or from top to bottom, as in either English or Japanese, a text node, which is located either above or to the left of the target element can be determined to have a stronger degree of association than a text node, which exists in another location (for example, to the right) with respect to the target element. Depending on the circumstances, a text node arranged below the target element will also have a strong degree of association with the target element.

As another determination index, there is a method which, in a case where multiple text nodes are arranged parallel to the target element, evaluates the degree of association between these text nodes and the target element as being low.

A method for calculating the degree of association based on the location of the text node in a case where the element for inputting the address “<input type=“text” id=“to” size=“100”>” in FIG. 21 is used as the target element will be explained. In this case, the degree of association with the “To:”, which is located to the left of the target element, is configured as “2”, and the degree of association with the “add CC” and the “add BCC”, which are located beneath the target element, are both configured as “1”. In addition, according to the method that lowers the degrees of association of multiple text nodes, which are arrayed, the degrees of association of the “add CC” and the “add BCC” are lowered to “0”. Therefore, ultimately, the degree of association with the “To:” is configured as “2”, and the degrees of association with the “add CC” and the “add BCC” are configured as “0”.

An example of deriving the degree of association based on the structural relationship between the target element and the adjacent text node will be explained. As methods for determining the degree of association based on the structural relationship, for example, there is a method for deriving the degree of association based on labeling, which uses a label element, a method for deriving the degree of association in accordance with whether or not the nodes are siblings, and a method for deriving the degree of association in accordance with whether or not the nodes are stored in the same row of a table. That is, the structural relationship between the target element and the adjacent text node can also be referred to as the relationship from the standpoint of the structure of the Web application screen.

In a case where the element for inputting the address “<input type=“text” id=“to” size=“100”>” in FIG. 21 is used as the target element, the degree of association with the “To:”, which is connected by a label element, can be configured as “1”. In this case, there are no sibling nodes, and the target element does not have a degree of association with any text node. In addition, since the “To:” is stored in the same row as the target element in the table structure, the degree of association can ultimately be “2”.

The definition of a sibling node may use a single element as a unit, or may use a partial element set as the unit. Specifically, in a partially structured text such as <div><div><div>A</div></div></div><div><div><div>B</div></d iv></div>, when it is supposed that <div><div><div>A</div></div></div> and <div><div><div>B </div></div></div> are each individual entities, the two are in a sibling node relationship.

The distance relationship-based degree of association, the physical relationship-based degree of association, and the structural relationship-based degree of association, which have ultimately been derived, are normalized, and all the degrees of association are consolidated (T220). The normalization method and the consolidation method are not stipulated in particular. As one example, there is a method, which adjusts the weight of each degree of association in accordance with a coefficient a, b, and c, and performs consolidation by adding all of the degrees of association together as shown in the following formula 1. In formula 1, the C is the final degree of association of the adjacent text node, a, b, and c are coefficients, D is the reciprocal of the distance, P is the degree of association using the physical relationship, and S is the degree of association using the structural relationship.

C=aD+bP+cS (Formula 1)

The degree of association derivation part 133 carries out the processing from Step T217 through T220 for all the text nodes stored in the array, which was buffered in Step T214.

In a case where the processing of Steps T217 through T220 has been completed for all the text nodes (T216: YES), the degree of association derivation part 133 derives an adjacent text node, which has the highest degree of association C of all the text nodes stored in the text node array, which was buffered in Step T214, and transfers this adjacent text node and the target element to the associated text element meaning inference part 134 (T222). The associated text element meaning inference part 134 is a function for inferring the meaning of the target element based on the adjacent text node.

The associated text element meaning inference part 134 analyzes the meaning of the target element based on the adjacent text node with the highest degree of association derived in Step T222 (T223). This meaning analysis process infers the meaning from the character string of the adjacent text node transferred from the degree of association derivation part 133 the same as in Step T108 described hereinabove.

Specifically, the associated text element meaning inference part 134 references the key-meaning pair stored in the meaning database (DB) 124, finds the key corresponding to the character string of the adjacent text node, and acquires the certainty factor corresponding to this meaning (T223).

The associated text element meaning inference part 134 transfers the certainty factor acquired in Step T223 to the element meaning inference part 135. At this point, the certainty factor derived by the associated text element meaning inference part 134 is written as an inferred probability Pb. Since this Pb is derived for each target element, an index is written together therewith. That is, the inferred probability derived by the associated text element meaning inference part 134 for a certain target element n is written as Pbn.

The element meaning inference part 135 derives the final inferred probability Pn for this target element from the inferred probability Pan transferred from the attribute element meaning inference part 123 and the inferred probability Pbn transferred from the associated text element meaning inference part 134. The method for calculating the inferred probability Pn does not particularly matter. As an example, there is a method, which calculates this inferred probability Pn by weighting in accordance with a coefficient β as shown in formula 2 below.

Pn=βPan+(1−β)Pbn (0≦β≦1) (Formula 2)

The element meaning inference part 135, in a case where the derived inferred probability Pn is equal to or larger than a (at least 0 and not more than 1), transfers the target element to either the text element buffer part 126 or the button element event addition part 136 (T203 and T204 of FIG. 9). The element meaning inference part 135 transfers the target element to the text element buffer part 126 in a case where the target element is a text box element (T110), and transfers the target element to the button element event addition part 136 in a case where the target element is a button element (T112).

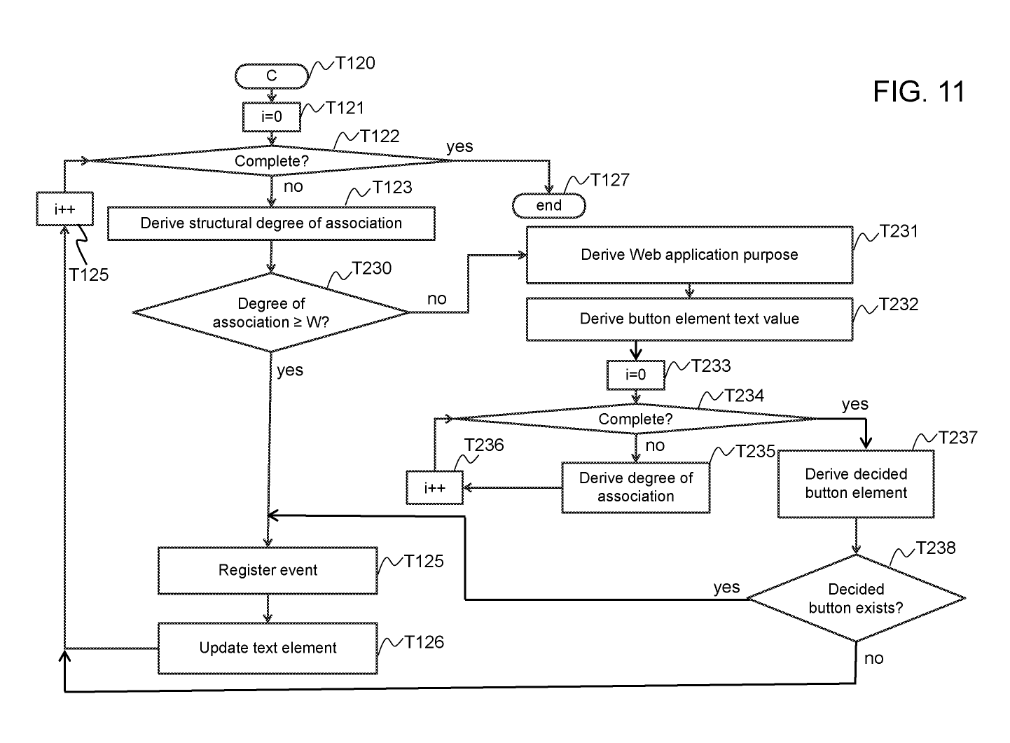

Next, the operation of the button element event addition part 136 will be explained using FIG. 11. The button element event addition part 136 carries out Steps T120 through T123 described using FIG. 3, and in a case where the degree of association derived in Step T123 is equal to or larger than a prescribed value W (T230: YES), carries out Step T125.

In the first example, an example is given of a degree of association derivation method, which determines in Step T123 that there is a structural degree of association with respect to a button inside the same form. However, this example does not comprise a submit button (<input type=“submit”>) as one element of the form. In addition, in a case where a button, which is not configured using either an input element or a button element having either “submit” or “button” as the type attribute, the degree of association is generally “0”. Consequently, in this example, Steps T231 through T238 are provided to cope with the above-mentioned problem.

The button element event addition part 136, in a case where it has been determined that the degree of association is less than the prescribed value W (T230: NO), determines the type of the Web application from the set of text box elements stored in the temporary memory 127 by the text element buffer part 126 using the method explained in Steps T133 through T136 (T231).

The button element event addition part 136 acquires all the character strings related to the set of button elements buffered in Step T113 (T232). The button element event addition part 136 initializes the loop variable i (T233), and derives the Web application degree of association for the entire set of button elements buffered in Step T113 (T235).

The method for deriving the Web application degree of association for each buffered button element is not limited in particular. As an example, the meaning DB 124 can be referenced using the character string acquired in Step T232 as a key the same as was described in Step T109, a “meaning” and a “certainty factor” corresponding to this character string can be acquired, and this certainty factor can be used as the Web application degree of association.

This will be explained by using the meaning DB 124 shown in FIG. 5 as an example. In a case where the character string obtained from the button element is “send”, the Web application degree of association is “1”. In a case where the character string obtained from the button element is “quxsend”, the Web application degree of association is “0.5”. In a case where the key corresponding to the character string obtained from the button element does not exist in the meaning DB 124, the Web application degree of association is “0”.

The button element event addition part 136 increments the loop variable i (T236), and returns to Step T234 in order to carry out Step T235 for the entire set of button elements, which were buffered in Step T113.

In a case where the Web application degree of association has been derived for the entire set of button elements buffered in Step T113 (T234: YES), the button element event addition part 136 treats the button element having the highest Web application degree of association as a candidate for the decided button element. The button element event addition part 136, in a case where the certainty factor of the decided button element candidate is equal to or larger than a prescribed value γ (0≦γ≦1), makes this candidate the decided button element (T237).

The button element event addition part 136, in a case where the decided button element has been determined (T238: YES), carries out Step T125. In a case where the decided button element has not been determined (T238: NO), the button element event addition part 136 moves to Step T125.

The method for outputting the operation log is the same as in the first example. A recommended value of coefficient β shown in Formula 2 may be proposed to the user at the time of operation log creation. For example, in a case where the coefficient β is configured to 0, and as a result of this, the inferred probability Pan=1 and the inferred probability Pbn=0.2, the value of coefficient β should be raised.

Configuring this example like this achieves the same effects as in the first example. In addition, in this example, it is possible to infer either the purpose or the meaning of an element (a div element or the like), which has a general-purpose attribute.

In this example, a user operation log can be acquired at a low load even for a Web application described using HTML, which comprises elements not having metadata capable of being used to infer a meaning, such as a schema or a DTD (Document Type Definition).

In this example, it is possible to support a Web application, which makes the user aware of a text box and a button by devising a style sheet or other such design without using a standardized text box element and button element. In this example, it is possible to support a Web application with a high degree of freedom of expression like this, and to infer the purpose or meaning thereof from an element presented to the user as a text box or a button. Then, it is possible to detect the degree of association between a set of extracted text box elements and an extracted button element.

In addition, in this example, it is possible to derive the degree of association between an element recognized by the user as a button, and a set of text box elements, and to infer the main purpose of the Web application from multiple elements and the meanings thereof. In this example, it is possible to acquire at an appropriate timing a character string, which a user inputted to a text box element, and lastly, to acquire a log of the operations of the user on the Web application.

### Example 3

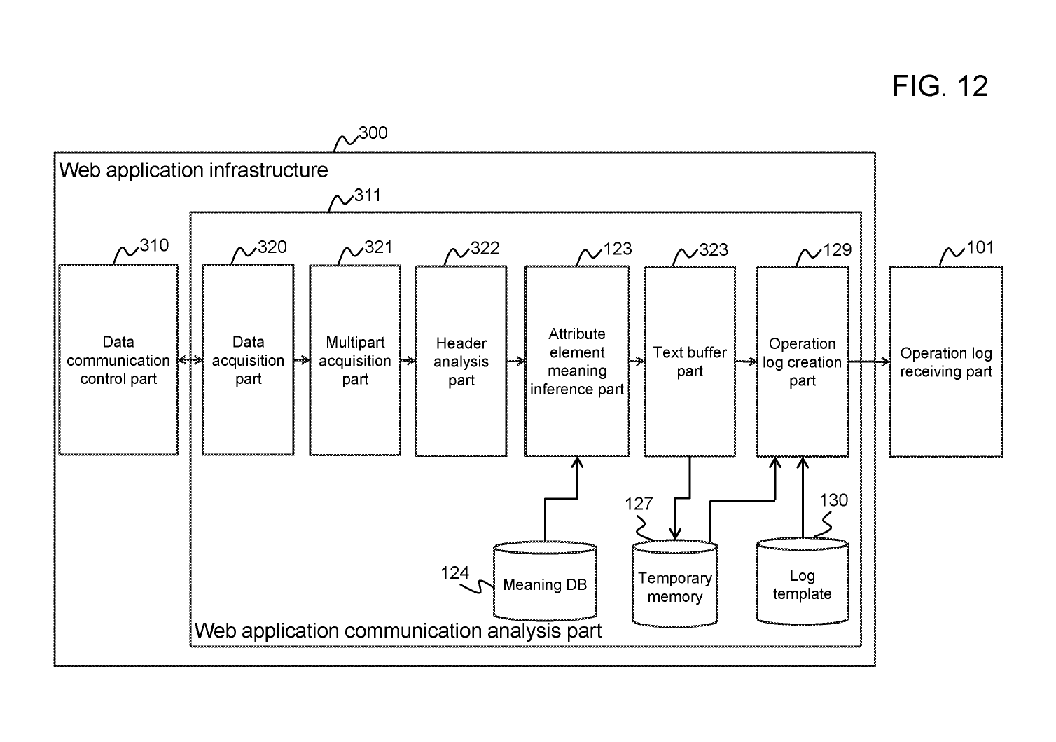

A third example will be explained by referring to FIGS. 12 through 14. As Web applications, for example, there is a Webmail application for creating, sending and receiving email on the Web, and a Web document creation application for creating and storing documents on the Web.

Among these Web applications, there is an application for automatically sending and backing up a user-inputted character string on a Web application provision server. For example, a Web application of this type acquires a user-inputted character string either at the time the user inputted the character string or on a regular basis, and sends this character string to the server. Accordingly, in this example, an operation log is acquired for a Web application, which automatically sends a user-inputted character string to a server.

In the first example, an explanation was given using an example of a case in which a user-inputted character string is sent to a Web application provision server at the time the user selects the send execution button. In this example, a case in which a user-inputted character string is automatically sent to the Web application provision server at a prescribed timing rather than when the send execution button is operated will be assumed.

FIG. 12 is a block diagram of a Web application analysis system related to this example. A Web application infrastructure 300 comprises a data communication control part 310 and a Web application communication analysis part 311.

The data communication control part 310 is a module in charge of controlling communications in the Web application infrastructure 300. The data communication control part 310 controls the processing of a request and the receiving of a response when reading a Web application resource and executing the Web application.

The Web application communication analysis part 311 monitors the communications of the Web application. The communication monitoring method of the Web application communication analysis part 311, that is, the location where the Web application communication analysis part 311 is implemented does not particularly matter. Examples of the communication monitoring method of the Web application communication analysis part 311 will be given below. However, the present invention is not limited to these examples.

As a first communication monitoring method, there is a method for penetrating inside the same memory space as the Web application infrastructure 300 as shown in FIG. 12. Generally speaking, a method called a global hook is used to hook an API, which the hook-target application uses. This makes it possible to transition control to the penetration module.

In the example of FIG. 12, the Web application communication analysis part 311 penetrates inside the Web application infrastructure 300, and changes the communication library API used by the data communication control part 310 to a pseudo API, which the Web application communication analysis part 311 prepares. This makes it possible for the Web application communication analysis part 311 to observe data, which the data communication control part 310 is attempting to communicate. This method is employed in the present example.

As a second communication monitoring method, there is a method for hooking the API used by the communication library. However, in a case where the communication library controls communications at a lower level than the HTTP, as in TCP/IP, for example, it is impossible to observe communications, which use the HTTPS (Hypertext Transfer Protocol over Secure Socket Layer). The HTTPS is communications, which utilize the SSL (Secure Socket Layer), and when the Web application infrastructure 300 communicates using HTTPS, it is not possible to observe the content of this communication.

A case in which data, which has been encoded in the HTTPS or other such HTTP layer, is generally observed at a lower level will be explained. In accordance with this, the encrypted communication channel between the Web application and the Web application provision server is partitioned before and after the Web application communication analysis module (the Web application communication analysis part 311). That is, the encrypted communication channel between the Web application and the server is partitioned between the Web application and the Web application communication analysis module, and between the Web application communication analysis module and the Web application provision server.

Then, for example, in a case where the Web application sends the Web application provision server data, which has been encrypted in accordance with the HTTPS, the Web application communication analysis module uses a cipher key for the communication channel between the Web application and the Web application communication analysis module to decrypt the encrypted data, and acquires the plaintext data.

In addition, it is necessary to carry out processing required for an analysis of one sort or another, and to use the cipher key for the communication channel between the Web application communication analysis module and the Web application provision server to encrypt the plaintext data.

As a third communication monitoring method, there is a method for implementing the Web application communication monitoring module as proxy software. This method must deal with the SSL the same as in the second method.

As a fourth method, there is a method for implementing the Web application communication monitoring module as either a physical proxy server or a physical gateway. This method, too, must cope with the SSL the same as the second and third methods.

The Web application communication analysis part 311 comprises a data acquisition part 320, a multipart extraction part 321, a header analysis part 322, the attribute element meaning inference part 123, the meaning DB 124, a text buffer part 323, the temporary memory 127, the operation log creation part 129, and the log template 130.

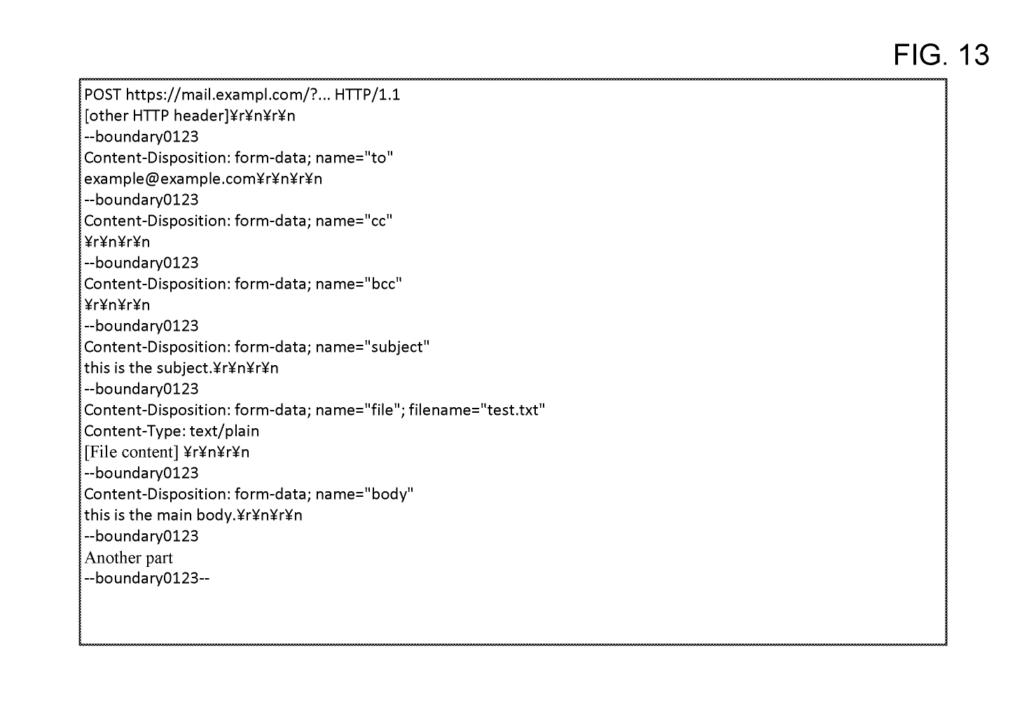

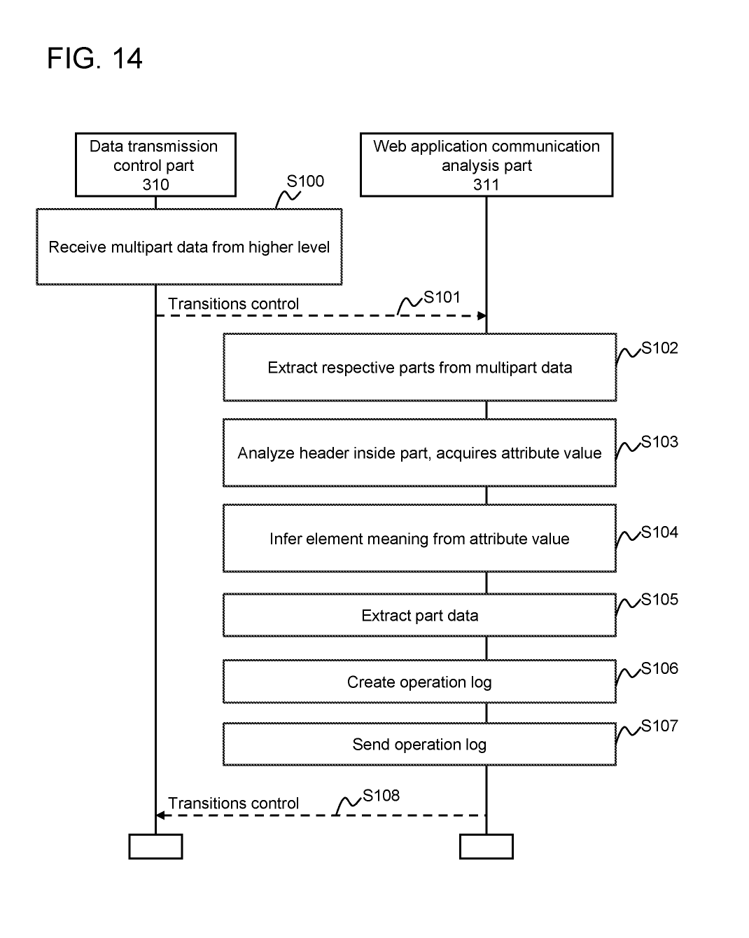

The operation of the Web application communication analysis part 311 will be explained by referring to FIG. 14. FIG. 13 shows an example of analysis-target data. FIG. 13 has been prepared to facilitate the explanation, and the analysis-target data of this example is not limited to that shown in FIG. 13.

The data communication control part 310 receives multipart data from a higher-level module of the Web application infrastructure 300 (S100). Thereafter, the data communication control part 310 also calls a lower-level library and invokes a pseudo API of the Web application communication analysis part 311 (S101). As a result of this, the data acquisition part 320 is able to receive data, which the data communication control part 310 is attempting to communicate. The multipart data of this example is data comprising multiple parts, and is an aggregate of the parts of the data. For example, in a case where the Web application is an electronic mail application, multipart data comprising data of multiple parts, such as an address part, a subject part, and a message part, is sent to the server for the provision of this Web application.

The multipart extraction part 321 partitions the multipart data into each part, and extracts each part of the data (S102).

The header analysis part 322 selects one part from the multiple parts extracted in Step S102 as a processing-target part, acquires header information from the processing-target part, and, in addition, acquires an attribute value from the header information (S103). In the case of FIG. 13, the header analysis part 322 acquires the value of the name header, specifically, the values of “to” and “cc”.

The attribute element meaning inference part 123 performs the same processing as that described using Steps T108 and T109 of FIG. 2 (S104).

The text buffer part 323 extracts body data from within the processing-target part, and performs the same processing as that of T111 (S105).

The Web application communication analysis part 311 repeatedly carries out the processing from Steps S102 through S105 for all the part data.

The operation log creation part 129 performs the same processing as the processing described in Steps T136 through T138 of FIG. 4, creates an operation log (S106), and sends the created operation log to the operation log receiving part 101 (S107).

The Web application communication analysis part 311 invokes the real API, which is the target of the pseudo API, and lastly, returns control to the data communication control part 310 (S108).

Configuring this example like this also makes it possible to monitor user operations with respect to the Web application, and to acquire and store an operation log. In addition, since the communications between the Web application and the Web application provision server are monitored in this example, it is possible to acquire a log of user operations on the Web application from the data sent from the Web application to the server. Therefore, an operation log can be acquired even in a case where the Web application automatically acquires a user-inputted character string (data) and sends this character string to the server.

### Example 4

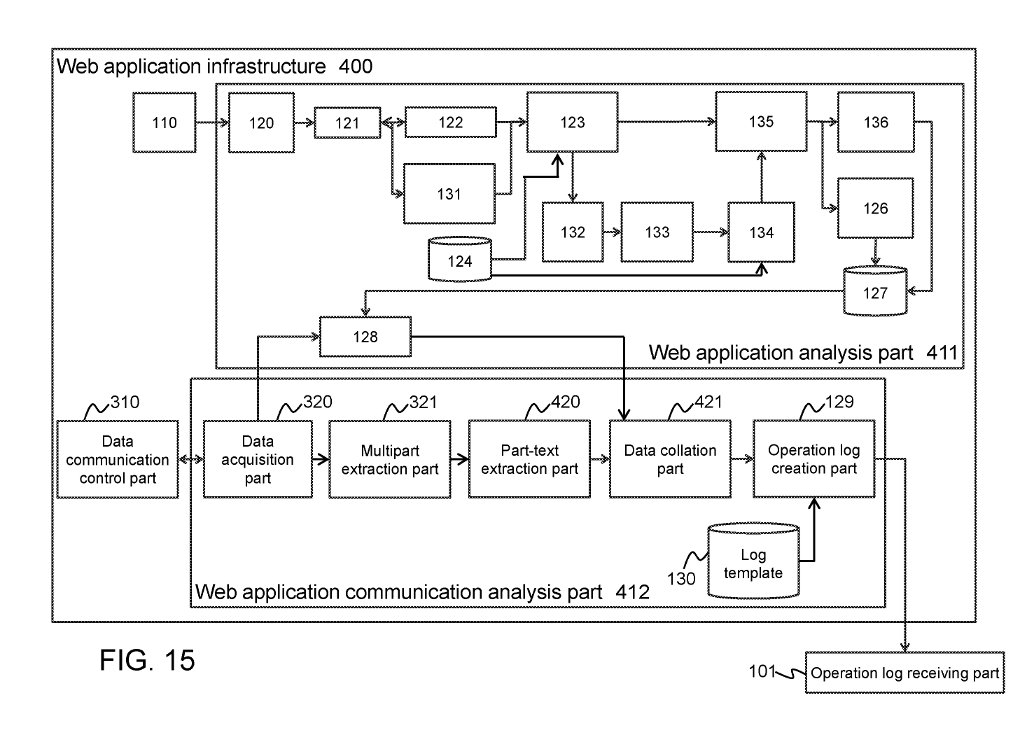

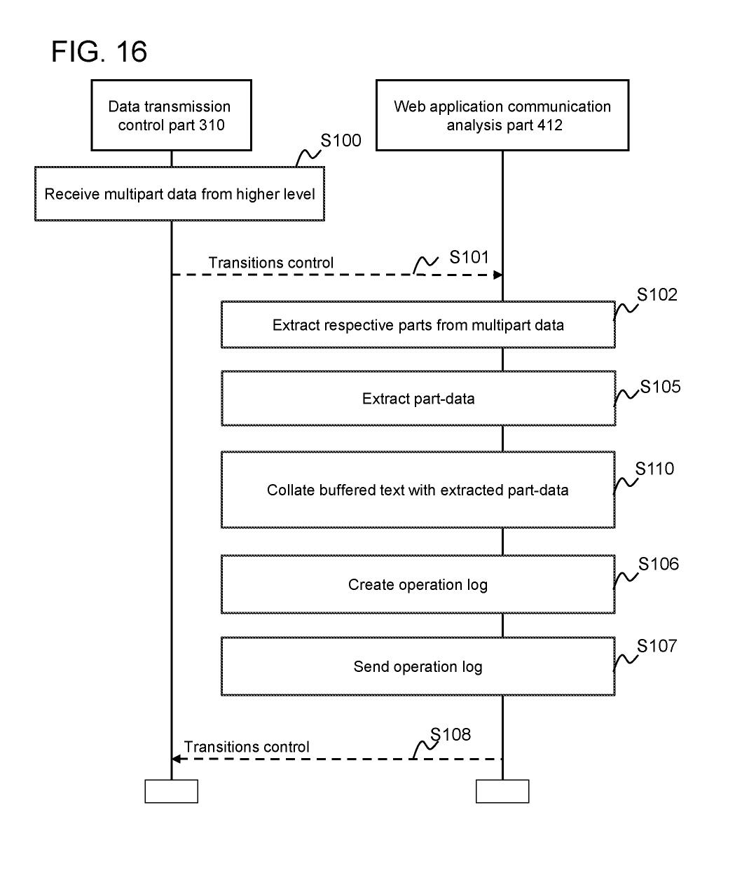

A fourth example will be explained by referring to FIGS. 15 and 16. This example also assumes a case in which a user-inputted character string is automatically sent to the Web application provision server the same as the above-mentioned third example.

FIG. 15 shows an example of the configuration of a Web application analysis system related to this example. In the block diagrams that follow, the names of the blocks may be omitted and only the reference signs shown.

A Web application infrastructure 400 comprises the event generation part 110, a Web application analysis part 411, the data communication control part 310, and a Web application communication analysis part 412.

The Web application analysis part 411 in this example comprises a configuration, which resembles the Web application analysis part 211 described in the second example, and a configuration, which resembles the Web application analysis part 311 described in the third example.

That is, the Web application analysis part 411 comprises the event acquisition part 120, the element extraction part 121, the element analysis part 122, the attribute element meaning inference part 123, the meaning DB 124, the text element buffer part 126, the temporary memory 127, the text extraction part 128, the style analysis part 131, the adjacent text extraction part 132, the degree of association derivation part 133, the associated text element meaning inference part 134, the element meaning inference part 135, and the button element event addition part 136. The operations of these functional blocks are also the same as the operations described using FIGS. 9 through 11.

The Web application analysis part 411 of this example may comprise a configuration resembling that of the Web application analysis part 111 of the first example (a configuration having the event acquisition part 120 through the temporary memory 127) instead of the configuration, which resembles the Web application analysis part 211 of the second example. That is, this example can be described as a combination of the second example and the third example, and can also be described as a combination of the first example and the third example.

The Web application communication analysis part 412 comprises the data acquisition part 320, which is an example of the “communication acquisition part”, the multipart extraction part 321, a part-text extraction part 420, a data collation part 421, the operation log creation part 129, and the log template 130. The data acquisition part 320 is an example of the “communication acquisition part”. The part-text extraction part 420 together with the multipart extraction part 321 comprise an example of the “communication character string extraction part”.

A communication monitoring method of the Web application communication analysis part 412, that is, the location where the Web application communication analysis part 412 is implemented does not particularly matter. To facilitate the explanation, this example uses a method for penetrating inside the same memory space as the Web application infrastructure 400 the same as in the third example. The Web application communication analysis part 412 may be disposed in an implementation location other than this.

The operation of the Web application communication analysis part 412 in this example will be explained by referring to FIG. 16. FIG. 13 will be used as an example of analysis-target data. FIG. 13 has been prepared to facilitate the explanation, and the analysis-target data of this example is not limited to the example shown in FIG. 13.

The Web application communication analysis part 412 carries out Steps S100 through S102 described using FIG. 14. Thereafter, the data acquisition part 320 notifies the text extraction part 128 of the fact that data has been acquired as event information.

The text extraction part 128, triggered by the event information notified from the data acquisition part 320, extracts the user-inputted data from all the text box elements stored in the temporary memory 127.

Meanwhile, the part-text extraction part 420 extracts the body text of each part (S105). In the example of FIG. 13, the “example@example.com” text is extracted from the name=“to” part.

The data collation part 421 compares and collates the text extracted in Step S105 with the user-inputted text extracted by the text extraction part 128 (S110). In a case where the result of the collation of Step S110 is that the data extracted from the part matches the user-inputted text, it is possible to determine into which text box the text extracted in Step S105 was inputted. This result makes it possible to infer the meaning of the text extracted in Step S105.

The data to be collated may be either all of the text or a portion of the text inside a part. A known method may be used as the text collation method. In this example, the text collation method does not particularly matter.

The repetition of Steps S102, S105, and S110 for all the parts makes it possible to determine the text, which is included in the data communicated by the data communication control part 310, and the meaning of this text.

The operation log creation part 129 uses the data comprising a pair of the determined text and its meaning to create an operation log (S106), and sends this operation log to the operation log receiving part 101 (S107). Thereafter, control is returned to the data communication control part 310 (S108).

Configuring this example like this also makes it possible to acquire a log of user operations with respect to the Web application. This example achieves the effects described in the second example and the third example. Or, as stated hereinabove, this example achieves the effects described in the first example and the third example by using a configuration, which resembles the Web application analysis part 111 of the first example as the Web application analysis part 411.

### Example 5

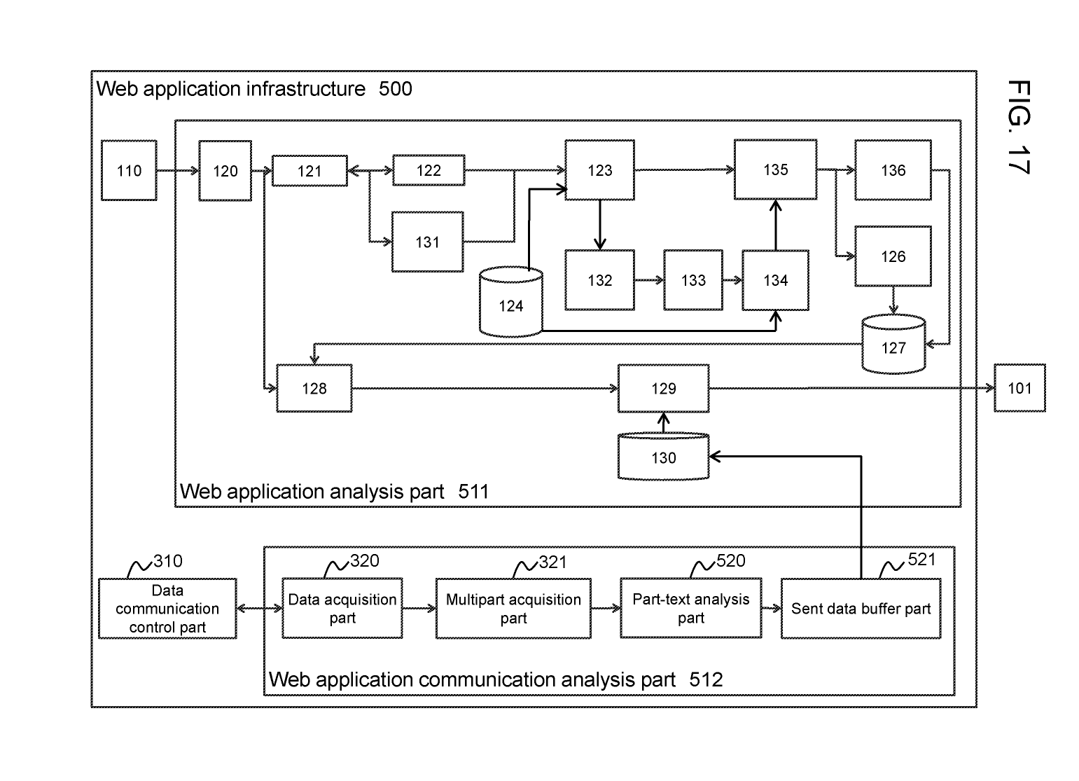

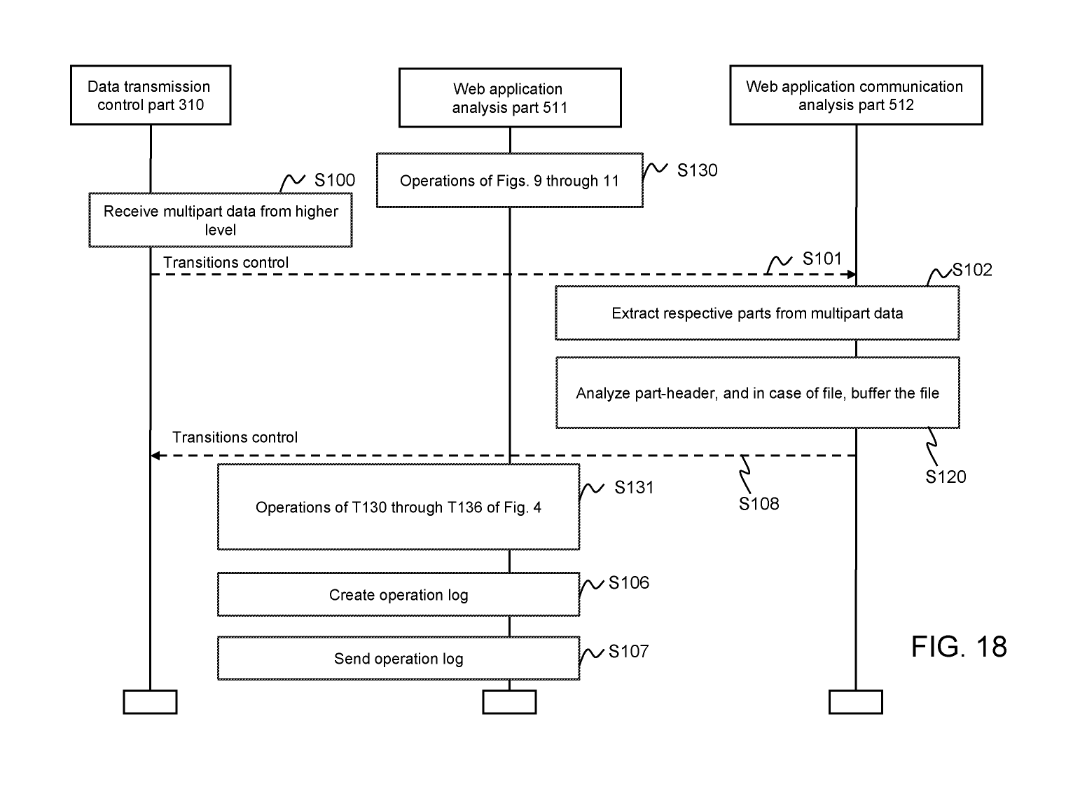

A fifth example will be explained by referring to FIGS. 17 and 18. This example assumes a case in which user data is divided into multiple pieces of data and sent to the server.

Specifically, in the Web application shown in FIG. 19, when the user performs an operation to attach a file to an email, the file attachment is sent to the Web application provision server before the user selects the button for executing the transmission of the email. This example supports this kind of case.

That is, it is a case in which a portion of the data is sent at a timing that differs from the selection of the send-execution by the user, and the other data is sent at the time of the send-execution selection by the user. In accordance with this, the user is executing a series of operations (operations for sending an email with a file attachment via the Web application). Therefore, the user operation log to be outputted should be consolidated into a single output. The log related to the file attachment and the log related to sending the email with the file attachment should not be separated.

FIG. 17 shows an example of the configuration of a Web application analysis system related to this example. A Web application infrastructure 500 comprises the event generation part 110, a Web application analysis part 511, the data communication control part 310, and a Web application communication analysis part 512.

The Web application analysis part 511 in this example comprises the event acquisition part 120, the element extraction part 121, the element analysis part 122, the attribute element meaning inference part 123, the meaning DB 124, the text element buffer part 126, the temporary memory 127, the text extraction part 128, the operation log creation part 129, the log template 130, the style analysis part 131, the adjacent text extraction part 132, the degree of association derivation part 133, the associated text element meaning inference part 134, the element meaning inference part 135, and the button element event addition part 136. The operational contents of these functional blocks 120 through 136 are as described using FIGS. 9 through 11.

The Web application analysis part 511 of this example comprises the same configuration as that of the Web application analysis part 211 described in the second example. This Web application analysis part 511 may also be configured so as to comprise a configuration resembling that of the Web application analysis part 111 described in the first example (the configuration from the event acquisition part 120 through the temporary memory 127).

The Web application communication analysis part 512 comprises the data acquisition part 320, the multipart extraction part 321, a part-text analysis part 520, and a send-data buffer part 521. A communication monitoring method of the Web application communication analysis part 512, that is, the location where the Web application communication analysis part 512 is implemented does not particularly matter. To facilitate the explanation, this example uses a method for penetrating inside the same memory space as the Web application infrastructure 500 the same as in the third example, but the present invention is not limited to this implementation location. The part-text analysis part 520 together with the multipart extraction part 321 comprise an example of the “file data extraction part”.

The operations of the Web application analysis part 511 and the Web application communication analysis part 512 of this example will be explained using FIG. 18. FIG. 13 will be used as an example of analysis-target data. FIG. 13 has been prepared to facilitate the explanation, and the present invention is not limited to the analysis-target data of this example.

The Web application analysis part 511 receives an event from the event generation part 110 and carries out the processing shown in FIGS. 9 through 11 (S130).

The data communication control part 310 receives multipart data from a higher level (S100), and calls a lower-level API. This transitions control to the Web application communication analysis part 512 (S101).

The Web application communication analysis part 512 extracts the data of each part from the multipart data (S102). Next, the part-text analysis part 520 analyzes the header of each part, and in a case where the content of the part is a file, stores information related to this file in the send-data buffer part 521 (S120).

The content of the “information related to the file”, which the part-text analysis part 520 sends to the send-data buffer part 521, does not particularly matter. For example, the information related to the file may comprise the file itself, a hash value of the file, a filename, and so forth. Furthermore, the part-header analysis content and analysis method of the part-text analysis part 520 do not particularly matter. The part-text analysis part 520, for example, analyzes whether the “filename” attribute is assigned to the header of the analysis-target part.

The Web application analysis part 511 receives an event from the event generation part 110, and carries out the Steps T130 through T136 described using FIG. 4 (S131).

Next, the operation log creation part 129 creates an operation log based on user-inputted character string information obtained from the text extraction part 128, and file information obtained from the send-data buffer part 521 (S106). The operation log creation part 129 sends the operation log to the operation log receiving part 101 (S107).

In a case where the data inputted to the operation log creation part 129 comprises only the user-inputted character string information obtained from the text extraction part 128, that is, a case in which the file information is not stored in the send-data buffer part 521, the same processing as that of the first example and the second example may be performed.

In a case where the data inputted to the operation log creation part 129 comprises only the file information obtained from the send-data buffer part 521, that is, a case in which the Web application is simply a type of application such as a file uploader, an operation log such as “file uploaded” is acquired.

In a case where the Web application is a file uploader or other such application, an event acquired by the event acquisition part 120 is an event for which a notification is issued at the time that a current session or page either ends or is about to end in the Web application.

Configuring this example like this also makes it possible to acquire a log of user operations with respect to a Web application. In addition, in this example, it is possible to acquire a single operation log even in a case where user-inputted data is divided into multiple parts during a series of user operations with respect to the Web application, such as attaching a file to an email and sending the email with file attachment. That is, in this example, rather than creating an operation log for each piece of divided data, a single operation log is created for a series of operations. Therefore, it is easier for the system administrator to monitor a user's operations with respect to a Web application, and usability is enhanced.

The present invention is not limited to the examples described hereinabove. A person with ordinary skill in the art will be able to make various additions and changes without departing from the scope of the present invention. For example, the scope of the present invention includes a configuration, which combines the first example and the third example, a configuration, which combines the first example and the fifth example, a configuration, which combines the fourth example and the fifth example, and a configuration, which combines the first example, the third example, and the fifth example.

In addition, the present invention, for example, can also be described as a computer program invention as follows.

### “Invention 1

A computer program for allowing a computer to function as a user operation detection system for detecting a user operation for a web application running on a server,

the above-mentioned computer program allowing the above-mentioned computer to realize:

a first element extraction part for extracting from an application screen, which is provided by the above-mentioned web application, both a character string input element for the user to input a character string and an execution instruction element for instructing the above-mentioned web application to execute a prescribed operation;

a role inference part for inferring a role, in the above-mentioned web application, of the extracted above-mentioned character string input element and the above-mentioned execution instruction element;

an element association part for associating the above-mentioned character string input element with the above-mentioned execution instruction element;

a character string extraction part for extracting an inputted character string, which has been inputted to the above-mentioned character string input element associated with the above-mentioned execution instruction element;

a template storage part for storing template data, which is prepared in accordance with a type of a web application, and is for recording a user operation with respect to the above-mentioned web application; and

a user operation record data creation part for acquiring from the above-mentioned template storage part template data corresponding to the above-mentioned inputted character string extracted by the above-mentioned character string extraction part, and based on the acquired template data and above-mentioned inputted character string, creating user operation record data, which records a user operation.

### Invention 2

A computer program according to Invention 1, wherein the above-mentioned application screen is formed from tree-structured data, in which multiple elements are arranged in a tree structure, and

the above-mentioned element association part associates the above-mentioned character string input element with the above-mentioned execution instruction element based on a structural relationship in the above-mentioned tree-structured data.

### Invention 3

A computer program according to either Invention 1 or 2, wherein the above-mentioned role inference part comprises a first role inference part for inferring, based on an attribute value of an inference-target element, the role of the above-mentioned inference-target element,

wherein the above-mentioned first role inference part:

infers the role of the above-mentioned character string input element based on an attribute value of the above-mentioned character string input element; and

infers the role of the above-mentioned execution instruction element based on an attribute value of the above-mentioned execution instruction element.

### Invention 4

A user operation detection system according to claim 3, wherein the first role inference part can use a role database for managing a keyword, a role, and a certainty factor after associating these with one another, and wherein

the first role inference part:

infers the role of the character string input element by acquiring from the role database a keyword, which is included in the attribute value of the character string input element, and a role and a certainty factor, which are associated with the same keyword as keyword included in the attribute value; and

infers the role of the execution instruction element by acquiring from the role database a keyword, which is included in the attribute value of the execution instruction element, and a role and a certainty factor, which are associated with the same keyword as keyword included in the attribute value.

### Invention 5

A computer program according to any one of Inventions 1 through 4, wherein the above-mentioned user operation record data creation part calculates a degree of conformity, which shows the extent to which the above-mentioned inputted character string conforms to various template data stored in the above-mentioned template storage part, and selects the template data with the highest degree of conformity as the template data corresponding to the above-mentioned inputted character string.

### Invention 6

A computer program according to Invention 5, wherein the above-mentioned user operation record data creation part outputs the degree of conformity of the selected the above-mentioned template data and the above-mentioned inputted character string after associating the same with the user operation record data.

### Invention 7

A computer program according to any one of Inventions 1 through 6, wherein the above-mentioned first element extraction part, the above-mentioned role inference part, and the above-mentioned element association part operate when a preconfigured first timing arrives, and

the above-mentioned character string extraction part and the above-mentioned user operation record data creation part operate when a preconfigured second timing arrives.

### Invention 8

A computer program according to any one of Inventions 1 through 7, wherein design data, which stipulates a design for the above-mentioned multiple elements forming the above-mentioned tree-structured data, is associated with the above-mentioned tree-structured data,

wherein the computer program further comprises a second element extraction part for extracting both the above-mentioned character string input element and the above-mentioned execution instruction element based on the above-mentioned design data, and

the above-mentioned role inference part further comprises a second role inference part for inferring a role of an inference-target element based on a prescribed associated element associated with the above-mentioned inference-target element,

wherein the above-mentioned second role inference part:

treats the above-mentioned character string input element and the above-mentioned execution instruction element extracted by the above-mentioned second element extraction part as inference-target elements;

acquires all the above-mentioned prescribed associated elements associated with the above-mentioned inference-target elements from the above-mentioned tree-structured data based on the above-mentioned design data;

acquires a prescribed degree of association showing the extent of association between the above-mentioned inference-target elements for each of the acquired prescribed associated elements;

selects one associated element from among the above-mentioned prescribed associated elements based on the above-mentioned prescribed degree of association; and

infers the respective roles of the above-mentioned inference-target, the above-mentioned character string input element, and the above-mentioned execution instruction element based on an attribute value of the selected prescribed associated element.

### Invention 9

A computer program according to Invention 8, wherein the above-mentioned prescribed associated element is a text element, which exists within a prescribed distance from the above-mentioned inference-target element.

### Invention 10

A computer program according to either one of Invention 8 or 9, wherein the above-mentioned prescribed degree of association is at least any one of a distance-based degree of association, a positional relationship-based degree of association, or a structural relationship-based degree of association.

### Invention 11

A computer program according to any one of Inventions 8 through 10, wherein the role of the above-mentioned inference-target element is determined based on a first inference result by the above-mentioned first role inference part and a second inference result by the above-mentioned second role inference part.

### Invention 12

A computer program according to any one of Inventions 1 through 11, further comprising:

a communication acquisition part for acquiring the content of communication between the above-mentioned client terminal and the above-mentioned server; and

a communication character string extraction part for extracting a character string from the above-mentioned content of communication,

wherein the above-mentioned user operation record data creation part:

identifies the corresponding relationship between the above-mentioned communication character string and the above-mentioned character string input element by collating the above-mentioned inputted character string extracted by the above-mentioned character storing extraction part with a communication character string extracted by the above-mentioned communication character string extraction part; and

creates the above-mentioned user operation record data based on the above-mentioned template data, which corresponds to the above-mentioned inputted character string, and the above-mentioned communication character string.

### Invention 13

A computer program according to any one of Inventions 1 through 12, further comprising:

a communication acquisition part for acquiring the content of communication from the above-mentioned client terminal to the above-mentioned server; and

a file data extraction part for extracting file data from the above-mentioned content of communication,

wherein the above-mentioned user operation record data creation part creates the above-mentioned user operation record data by including information related to the extracted file data.”

The present invention may also be described as follows.

### “Invention 1

A user operation detection system, comprising:

element-name element extracting means for inputting a structured text capable of configuring tree-structured data, and extracting from the above-mentioned tree-structured data an element into which the user is able to input a character string and a user-selectable button element using an element name and an attribute;

style element extraction means for inputting a structured text capable of configuring tree-structured data, and extracting from the inputted the above-mentioned tree-structured data an element into which the user is able to input a character string and a user-selectable button element by focusing on the style or design of the relevant element;

attribute element meaning inference means for deriving the purpose or meaning of a relevant element from an attribute value obtained from all the attributes of extracted elements;

element meaning inference means for deriving an element inference meaning Pn from the above-mentioned attribute inferred meaning Pan derived from the above-mentioned attribute element meaning inference means, and the above-mentioned adjacent text inferred meaning Pbn derived from the above-mentioned associated text element meaning inference means using the formula Pn=Pan+(1−β)Pbn (0≦β≦1);

associated text element meaning inference means for deriving a purpose or a meaning of a relevant element from a text adjacent to an extracted element;

element association means for associating a set of extracted elements into which the user is able to input a character string with a user-selectable button element;

conversion data providing means for providing a blank-fillable standard text or a text element-insertable structured text prepared for each Web application, to which meaning data corresponding to a blank in the case of a blank-fillable standard text, and a text element in the case of a text element-insertable structured text;

conversion text providing means for collating each set of meaning data obtained from an extracted set of elements into which a user is able to input a character string to a set of meaning data of either a blank-fillable standard text or a text element-insertable structured text provided by conversion data providing means, and selecting either the blank-fillable standard text or the text element-insertable structured text with the highest degree of conformity; and

text converting means for extracting a user-inputted character string, allocating the extracted user-inputted character string corresponding to the blank-fillable standard text or the text element-insertable structured text with the highest degree of conformity obtained by text converting means, for which meaning data conforms to a blank in the case of a blank-fillable standard text, and to a text element in the case of a text element-insertable structured text, and converting this extracted user-inputted character string to a text.

### Invention 2

A user detection system according to Invention 1, wherein an element into which the user is able to input a character string and a user-selectable button element are extracted from the above-mentioned inputted tree-structured data using style information in which a design conducive to a character string input and a design conducive to a button are specified in an item for which an element-name of a relevant element, or a pair of a relevant element element-name and a relevant element attribute, or a relevant element style is described.”

### REFERENCE SIGNS LIST

100 Web application infrastructure
101 Operation log receiving part
110 Event generation part
111 Web application analysis part
120 Event acquisition part
121 Element extraction part
122 Element analysis part
123 Attribute element meaning inference part
124 Meaning DB
125 Button element event addition part
126 Text element buffer part
127 Temporary memory
128 Text extraction part
129 Operation log creation part
130 Log template
131 Style analysis part
132 Adjacent text extraction part
133 Degree of association derivation part
134 Associated text element meaning inference part
135 Element meaning inference part
136 Button element event addition part
200 Web application infrastructure
211 Web application analysis part
300 Web application infrastructure
310 Data communication control part
311 Web application communication analysis part
320 Data receiving part
321 Multipart extraction part
322 Header analysis part
323 Text buffer part
400 Web application infrastructure
411 Web application analysis part
412 Web application communication analysis part
420 Part-text extraction part
421 Data collation part
500 Web application infrastructure
511 Web application analysis part
512 Web application communication analysis part
520 Part-text extraction part
521 Send-data buffer part

1. A user operation detection system, which detects a user operation performed in use of a client terminal for a web application running on a server, comprising:
a first element extraction part for extracting from an application screen, which is provided by the web application, both a character string input element for the user to input a character string and an execution instruction element for instructing the web application to execute a prescribed operation;
a role inference part for inferring a role, in the web application, of the extracted character string input element and execution instruction element;
an element association part for associating the character string input element with the execution instruction element;
a character string extraction part for extracting an inputted character string, which has been inputted to the character string input element associated with the execution instruction element;
a template storage part for storing template data, which is prepared in accordance with a web application type and is for recording a user operation with respect to the web application; and
a user operation record data creation part for acquiring from the template storage part template data corresponding to the inputted character string extracted by the character string extraction part, and, based on the acquired template data and inputted character string, creating user operation record data, which records a user operation.

2. A user operation detection system according to claim 1, wherein the application screen is formed from tree-structured data, in which multiple elements are arranged in a tree structure, and
the element association part associates the character string input element with the execution instruction element based on a structural relationship in the tree-structured data.

3. A user operation detection system according to claim 2, wherein
the role inference part comprises a first role inference part for inferring, based on an attribute value of an inference-target element, the role of the inference-target element, and wherein
the first role inference part:
infers the role of the character string input element based on an attribute value of the character string input element; and
infers the role of the execution instruction element based on an attribute value of the execution instruction element.

4. A user operation detection system according to claim 3, wherein the first role inference part can use a role database for managing a keyword, a role, and a certainty factor after associating these with one another, and wherein
the first role inference part:
infers the role of the character string input element by acquiring from the role database a keyword, which is included in the attribute value of the character string input element, and a role and a certainty factor, which are associated with the same keyword as keyword included in the attribute value; and
infers the role of the execution instruction element by acquiring from the role database a keyword, which is included in the attribute value of the execution instruction element, and a role and a certainty factor, which are associated with the same keyword as keyword included in the attribute value.

5. A user operation detection system according to claim 4, wherein the user operation record data creation part calculates a degree of conformity, which shows the extent to which the inputted character string conforms to various template data stored in the template storage part, and selects the template data with the highest degree of conformity as the template data corresponding to the inputted character string.

6. A user operation detection system according to claim 5, wherein the user operation record data creation part outputs the degree of conformity of the selected the template data and the inputted character string after associating the same with the user operation record data.

7. A user operation detection system according to claim 6, wherein the first element extraction part, the role inference part, and the element association part operate when a preconfigured first timing arrives, and
the character string extraction part and the user operation record data creation part operate when a preconfigured second timing arrives.

8. A user operation detection system according to claim 7, wherein
design data, which stipulates a design for the multiple elements forming the tree-structured data, is associated with the tree-structured data, wherein
the user operation detection system further comprises a second element extraction part for extracting both the character string input element and the execution instruction element based on the design data, and
the role inference part further comprises a second role inference part for inferring a role of an inference-target element based on a prescribed associated element associated with the inference-target element, and wherein
the second role inference part:
treats the character string input element and the execution instruction element extracted by the second element extraction part as inference-target elements;
based on the design data, acquires from the tree-structured data all the prescribed associated elements associated with the inference-target element;
acquires a prescribed degree of association showing the extent of association with the inference-target element for each of the acquired prescribed associated elements;
selects one associated element from among the prescribed associated elements based on the prescribed degree of association; and
infers the respective roles of the inference-target character string input element and the execution instruction element based on an attribute value of the selected prescribed associated element.

9. A user operation detection system according to claim 8, wherein the prescribed associated element is a text element, which exists within a prescribed distance from the inference-target element.

10. A user operation detection system according to claim 9, wherein the prescribed degree of association is at least any one of a distance-based degree of association, a positional relationship-based degree of association, or a structural relationship-based degree of association.

11. A user operation detection system according to claim 10, wherein the role of the inference-target element is determined based on a first inference result by the first role inference part and a second inference result by the second role inference part.

12. A user operation detection system according to claim 1, further comprising:
a communication acquisition part for acquiring a content of communication between the client terminal and the server; and
a communication character string extraction part for extracting a character string from the content of communication, wherein
the user operation record data creation part:
identifies the corresponding relationship between the communication character string and the character string input element by collating the inputted character string extracted by the character string extraction part with a communication character string extracted by the communication character string extraction part; and
creates the user operation record data based on the template data, which corresponds to the inputted character string and the communication character string.

13. A user operation detection system according to claim 1, further comprising:
a communication acquisition part for acquiring a content of communication from the client terminal to the server; and
a file data extraction part for extracting file data from the content of communication, wherein
the user operation record data creation part creates the user operation record data by including information related to the extracted file data.

14. A user operation detection system according to claim 7, wherein
the first timing is a timing when read of the tree-structured data for configuring the application screen has been completed, and
the second timing is a timing when an operation with respect to the execution instruction element associated with the character string input element has been detected.

15. A user operation detection method for detecting in a client terminal a user operation performed using a client terminal with respect to a web application running on a server, with the client terminal being configured to comprise a memory for storing a prescribed computer program, a microprocessor for reading the prescribed computer program from the memory and executing the program, and a communication interface circuit for communicating with the server,
the client terminal, in accordance with the microprocessor executing the prescribed computer program, executing:
a first element extraction step of extracting from an application screen, which is provided by the web application, both a character string input element for the user to input a character string and an execution instruction element for instructing the web application to execute a prescribed operation;
a role inference step of inferring a role in the web application of the extracted character string input element and the execution instruction element;
an element association step of associating the character string input element with the execution instruction element;
a character string extraction step of extracting an inputted character string, which is inputted to the character string input element associated with the execution instruction element; and
a user operation record data creation step of acquiring from a template storage part for storing template data, which is prepared in accordance with a web application type and is for recording a user operation with respect to the web application, template data corresponding to the inputted character string extracted in the character string extraction step, and, based on the acquired template data and the inputted character string, creating user operation record data, which records the user operation.
